(19) United States
(12) Patent Application Publication
(10) Pub. No.: US 2025/0314983 A1
(43) Pub. Date: Oct. 9, 2025

(54) TONER

(71) Applicant: CANON KABUSHIKI KAISHA, Tokyo (JP)

(72) Inventors: TORU ISHII, Shizuoka (JP); KAZUYUKI SATO, Kanagawa (JP); SHOHEI TSUDA, Shizuoka (JP); KENYA TERADA, Shizuoka (JP); KOSUKE FUKUDOME, Tokyo (JP)

(21) Appl. No.: 19/169,907

(22) Filed: Apr. 3, 2025

(30) Foreign Application Priority Data
Apr. 8, 2024 (JP) 2024-061897
Mar. 12, 2025 (JP) 2025-039231

(51) Int. Cl. G03G 9/087; G03G 9/097

(52) U.S. Cl. CPC G03G 9/08755; G03G 9/09716

(57) ABSTRACT

A toner includes a toner particle that contains a binder resin, and an external additive. The binder resin contains 50% by mass or greater of polyester A, and the polyester A contains 90% by mole or greater of an isophthalic acid unit Uᵢₛₒ with respect to an amount of all units derived from an acid component. The external additive contains a titanate fine particle.

### BACKGROUND

### Technical Field

The present disclosure relates to a toner used in an electrophotographic image forming apparatus.

### Description of the Related Art

An electrophotographic apparatus is required to further speed up the process and be further miniaturized. Therefore, there has been a demand for further improvement of various performances of a toner in order to realize the above-described requirements.

For example, there has been a demand for a toner having satisfactory fixability in order to contribute to speed up the process of an electrophotographic apparatus and to miniaturize the apparatus. When a toner has satisfactory fixability, since the toner can be fixed to paper with a small heat quantity, the printing speed can be set to be high. Further, the toner with satisfactory fixability can also contribute to miniaturization of a fixing member. In addition, there has also been a demand for a toner with satisfactory transferability. Since the amount of toner remaining on a latent image bearing member decreases during transfer, the amount of waste toner to be recovered by a cleaning member is reduced, and thus the capacity of a waste toner container can be reduced. Under the above-described circumstances, the requirement for improving the fixability and the transferability of a toner has been increasing more than ever.

For example, Japanese Patent Laid-Open No. 2017-003851 discloses a toner that contains an amorphous composite resin having a polycondensation resin component obtained by polycondensing an alkylene oxide adduct of bisphenol A, an isophthalic acid compound, and an aliphatic saturated carboxylic acid compound in order to obtain a toner with excellent low-temperature fixability.

Japanese Patent Laid-Open No. 2019-049629 discloses a toner that controls a state where a release agent is present and dynamic viscoelasticity of toner particles and further controls the proportion of isophthalic acid in the entire polycarboxylic acid of polyester contained as a binder resin. In a case where such a toner is used, occurrence of offset on other recording media can be suppressed when writing is performed on a rear surface of a recording medium on which a solid image is formed.

As a result of examination repeatedly performed by the present inventors, the toner described in Japanese Patent Laid-Open No. 2017-003851 is found to have a certain degree of an effect of improving the low-temperature fixability by using a toner that contains polyester having a unit derived from isophthalic acid as a binder resin. Further, the toner described in Japanese Patent Laid-Open No. 2019-049629 exhibits an effect of improving the offset of a fixed image to a certain degree due to a high affinity for a release agent of isophthalic acid.

However, in the toners described in the documents described above, transfer efficiency is degraded and voids occur due to transfer defects in some cases when the toners are used in a low-temperature and low-humidity environment.

### SUMMARY

The present inventors have conducted intensive examination on the fixability of a toner and anti-contamination properties of a charging member in order to address the above-described disadvantages. As a result, it has been found that toner particles are capable of achieving both the fixability of the toner (offset of a solid image and fixability of a halftone image in a low-temperature and low-humidity environment) and the transferability (transfer efficiency of a solid image and transferability of a thin vertical line) only when the toner particles contain a specific amount or greater of polyester A having a certain amount or greater of an isophthalic acid unit and contain an external additive containing titanate fine particles.

That is, according to the present disclosure, there is provided a toner including: a toner particle that contains a binder resin; and an external additive, in which 1) the binder resin contains 50% by mass or greater of polyester A, and the polyester A contains 90% by mole or greater of an isophthalic acid unit Uᵢₛₒ with respect to an amount of all units derived from an acid component, and 2) the external additive contains a titanate fine particle.

Further features of the present disclosure will become apparent from the following description of exemplary embodiments with reference to the attached drawings.

### DESCRIPTION OF THE EMBODIMENTS

In the present disclosure, the description of a numerical range of “OO or greater and XX or less” or “OO to XX” denotes a numerical range including the endpoints as the lower limit and the upper limit unless otherwise specified.

### Establishing Process and Significance of Present Disclosure

As described above, in order to improve the fixability of a toner, it is effective to allow toner particles to contain polyester having a large amount of isophthalic acid units as a main component of a binder resin.

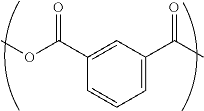

However, in a case where the process speed of an electrophotographic apparatus is increased, a decrease in transfer efficiency and voids in thin vertical lines are found in some case when the electrophotographic apparatus is used in a low-temperature and low-humidity environment. Further, the term “unit” in the present disclosure denotes a partial structure present in a polymer. For example, an isophthalic acid unit denotes a structure in which an ester bond is formed in two carboxy group moieties of the isophthalic acid as described above. The same applies to “unit of an ethylene oxide adduct of bisphenol A” described below, and this unit denotes a structure in which an ester bond is formed in two hydroxy group moieties of the ethylene oxide adduct of the bisphenol A. The same applies to other cases.

The transfer process in the electrophotography is a process in which a toner image formed on the surface of a latent image bearing member is moved and adheres to paper, and it is important to move the toner image on the latent image bearing member obtained in a development process to paper as it is without distorting the toner image in order to obtain a high-quality image. In the transfer process, a nip is formed between a latent image bearing member (photoreceptor), an intermediate transfer member (intermediate transfer belt), and paper so that the toner on the latent image bearing member moves to the intermediate transfer member and the paper when a transfer bias is applied thereto. At this time, degradation of transferability, in which some of the toner on the latent image bearing member does not properly move to the intermediate transfer belt or the paper and remains on the latent image bearing member, occurs. Specifically, degradation of transfer efficiency in a case of outputting a solid image and voids in a case of outputting thin vertical lines occur. When the process speed of the electrophotographic apparatus is increased, the time required for the toner at the nip to move in the transfer process is shortened, and thus the transfer process is susceptible to the transferability.

As a result of examination repeatedly conducted by the present inventors, it has been found that in a case where toner particles contain polyester having an isophthalic acid unit, the electrostatic adhesive force of the toner particles is increased when printing is performed in a low-temperature and low-humidity environment, and thus degradation of transfer efficiency in a solid image and voids in a thin vertical line image occur.

The reason for this is unclear, but the degradation and the voids described above are assumed to be caused by the isophthalic acid unit having irregularities in a microscopic electric charge because oxygen atoms of the carbonyl group bonded to a benzene ring of the isophthalic acid unit are likely to be aligned. The bias in the electric charge is significant in a low-temperature and low-humidity environment, and countless minute electric fields are formed due to the irregularities in the electric charge on the surface of the toner. In a case where minute electric fields are present, an attractive force, referred to as a gradient force, is known to be generated, and this attractive force strongly acts on a highly insulating surface. Therefore, it is assumed that the electrostatic adhesive force to the latent image bearing member is increased in the toner particles containing polyester that has an isophthalic acid unit.

Therefore, the present inventors have conducted intensive examination on a method of suppressing an increase in adhesive force between the toner and the latent image bearing member in the toner particles containing polyester that has a large amount of isophthalic acid units as a main binder resin component. As a result, it has been found that both the fixability of the toner and the transferability of the toner can be achieved in a case where the toner contains titanate fine particles, thereby completing the present disclosure.

That is, according to the present disclosure, there is provided a toner including a toner particle that contains a binder resin, and an external additive, in which 1) the binder resin contains 50% by mass or greater of polyester A, and the polyester A contains 90% by mole or greater of an isophthalic acid unit Uᵢₛₒ with respect to an amount of all units derived from an acid component, and 2) the external additive contains a titanate fine particle.

### Main Configuration of Present Disclosure

With the above-described configuration, the transferability of the toner is considered to be enhanced by the following mechanism. The toner of the present disclosure contains an external additive containing titanate fine particles, and thus the titanate is polarized when placed in an electric field. Further, since the toner particles of the present disclosure contain a specific amount of polyester A having a specific amount of an isophthalic acid unit as a binder resin, the toner particles have a plurality of irregularities in microscopic electric charges caused by the isophthalic acid unit. The irregularities in the microscopic electric charges denote the presence of minute electric fields, and thus the coexistence of the isophthalic acid unit and the titanate fine particles results in polarization of the titanate fine particles and generation of an electric field oriented inversely to the electric field. In this manner, it is considered that the microscopic electric field on the toner is cancelled out due to the inversely oriented electric field generated by the presence of the titanate fine particles, and thus generation of a gradient force caused by the minute electric fields on the surface of the toner is suppressed. As a result, it is assumed that an increase in the electrostatic adhesive force is suppressed, and the transferability in a low-temperature and low-humidity environment is enhanced.

The polyester A according to the present disclosure has a unit Uro of an ethylene oxide adduct of bisphenol A and a unit U_{PO} of a propylene oxide adduct of bisphenol A, and the total content proportion of the unit U_{EO} and the unit U_{PO} is preferably 90% by mole or greater with respect to the amount of all units derived from an alcohol component. The ethylene oxide adduct of bisphenol A and the propylene oxide adduct of bisphenol A have a property of being easily plasticized by wax or crystalline polyester contained in the toner particles when heated an melted during fixation. Therefore, in a case where the content of units is in the above-described range, the binder resin is plasticized and likely to soak into fibers of paper when the ethylene oxide adduct and the propylene oxide adduct are heated and melted during fixation. As a result, the adhesiveness of the toner to paper is further increased, and the resistance to offset of an image and the resistance to a decrease in rubbing density of an image can be enhanced.

The expression “U_{EO}/(U_{EO}+U_{PO})×100”, which is the content proportion of the unit U_{EO} with respect to the total content proportion of the unit U_{EO} and the unit U_{PO}, is preferably 15% by mole or greater and 40% by mole or less.

The unit U_{PO} is a unit that has carbon atoms more than the carbon atoms of the unit U_{EO} and has propylene oxide having a branched structure. Therefore, the unit U_{PO} has a polarity lower than that of the unit U_{EO}. On the contrary, the unit U_{EO} has a polarity higher than that of the unit U_{PO}. In a case where U_{EO}/(U_{EO}+U_{PO})×100 is 15% by mole or greater, since the polarity of the polyester A is increased, the affinity for paper is increased, and thus offset of an image can be suppressed. Further, in a case where U_{EO}/(U_{EO}+U_{PO})×100 is 40% by mole or less, since the polarity of the polyester A is decreased, the electrostatic adhesive force caused by the polarity is reduced, and thus the transfer efficiency is enhanced.

The number average molecular weight (Mn) and the weight-average molecular weight (Mw) of tetrahydrofuran (THF) soluble matter of the polyester A, which are measured by gel permeation chromatography (GPC), can satisfy the following requirements.
3,000≤Mn≤10,000
Mw/Mn≥2.5

In a case where the number average molecular weight (Mn) thereof is 3,000 or greater, the toughness of the toner after fixation is increased, and thus the resistance to image offset is enhanced. Meanwhile, in a case where the number average molecular weight (Mn) thereof is 10,000 or less, the melt fluidity of the binder resin during fixation is increased so that the toner is likely to soak into fibers of paper, and thus the resistance to a decrease in rubbing density of the fixed image is enhanced.

Further, in a case where the ratio (Mw/Mn) is 2.5 or greater, this indicates that the molecular weight distribution of the polyester A is sufficiently wide. Accordingly, since the melt fluidity at a low temperature is increased, and entanglement sufficiently occurs between molecular chains, the toner is likely to soak into fibers of paper, and therefore, the resistance to a decrease in rubbing density of the fixed image is enhanced.

The toner particles may contain 0.015% by mass or greater and 0.150% by mass or less of an aluminum element. When the toner particles contain 0.015% by mass or greater of an aluminum element, the toughness is increased due to a crosslinked structure with the resin, and thus the resistance to image offset is enhanced. When the content of the aluminum element is 0.150% by mass or less, satisfactory low-temperature fixability can be obtained.

The aluminum element can be contained in the toner particles by using an aluminum source as an internal additive or an aggregating agent. Particularly, the aluminum element can be contained in the toner particles after the aluminum element enters a state of being ionized in an aqueous medium, and thus an aluminum source is desirably added to the toner particles as an aggregating agent from the viewpoint of achieving uniformity.

The binder resin in the present disclosure can further contain crystalline polyester. In a case where the binder resin contains crystalline polyester, the toner has satisfactory low-temperature fixability, and the resistance to a decrease in rubbing density of a fixed image is enhanced. The polyester suitable as the crystalline polyester will be described below.

The toner of the present disclosure has an average circularity of preferably 0.950 or greater and 0.980 or less. In a case where the average circularity is in the above-described range, the transferability in a wide range of environments is enhanced. Specifically, in a case where the average circularity thereof is 0.950 or greater, the contact area between the toner particles and the latent image bearing member is decreased, and thus the transfer efficiency can be enhanced.

Meanwhile, in a case where the average circularity thereof is 0.980 or less, since the rolling properties of the toner are improved, locally excessive charge-up is suppressed. Therefore, the electrostatic adhesive force is decreased, and thus the transferability in a low-temperature and low-humidity environment can be enhanced. The average circularity of the toner is more preferably 0.955 or greater and 0.975 or less.

A method of producing a chemical toner, such as an emulsion aggregation method, a suspension polymerization method, or a suspension granulation method, can be employed as the method of producing a toner in order to adjust the circularity of the toner to be in the above-described preferable ranges.

Further, in a case where an emulsion aggregation method is used, the circularity can be adjusted by providing a spheronization step in order to obtain a surface shape of a desired toner.

In a case where a pulverization method is used, the circularity of the toner can also be adjusted by performing a surface treatment, which is a thermal spheronization treatment, using hot air.

The toner of the present disclosure contains an external additive containing titanate fine particles. The toner can contain at least one selected from strontium titanate, calcium titanate, and barium titanate as the titanate fine particles. In this manner, the titanate fine particles are likely to be polarized, and thus generation of the gradient force on the surface of the toner can be effectively suppressed. Therefore, the transferability in a low-temperature and low-humidity environment can be enhanced.

The relative dielectric constant of the titanate fine particles according to the present disclosure is preferably 100 or greater and 2,000 or less from the viewpoint that polarization of the titanate fine particles is likely to occur so that generation of the gradient force on the surface of the toner can be effectively suppressed, and thus the transferability in a low-temperature and low-humidity environment can be enhanced.

The content of the titanate fine particles in the toner of the present disclosure is preferably 0.01% by mass or greater and 5.00% by mass or less. In a case where the content of the titanate fine particles is 0.01% by mass or greater, the generation of the gradient force caused by the irregularities in the electric charge derived from the isophthalic acid unit can be sufficiently suppressed, and thus the transferability in a low-temperature and low-humidity environment can be enhanced. Further, in a case where the content of the titanate fine particles is 5.00% by mass or less, the fixability at a low-temperature can be satisfactorily maintained. Particularly, the content of the titanate fine particles is more preferably in a range of 0.1% by mass or greater and 1.00% by mass or less from the viewpoint that both the fixability and the transferability at a low temperature can be achieved at a high level.

In the present disclosure, in a case where the content of the titanate fine particles with respect to 100 parts by mass of the toner particles is defined as A (parts by mass), the content proportion of the isophthalic acid unit Uᵢₛₒ with respect to the amount of all units derived from an acid component constituting the polyester A is defined as B (% by mole), and the content proportion of the polyester A in the binder resin is defined as C (% by mass), A, B, and C may satisfy the following expression.

$$1.0 \times 1 {0}^{- 5} \leq A / ( B \times C ) \leq 1.1 \times 1 {0}^{- 4} \qquad ( 1 )$$

When A/(B×C) is 1.0×10⁻⁵ or greater, a sufficient amount of a titanate is present with respect to the amount of the isophthalic acid unit contained in the toner particles, and accordingly, the transferability is enhanced. Further, when A/(B×C) is 1.1×10⁻⁵ or less, the fixability at a low temperature can be satisfactorily maintained. Particularly, when A/(B×C) is in a range of 3.1×10⁻⁵ or greater and 4.3×10⁵ or less, both the fixability and the transferability can be achieved at a high level.

In a case where the surface of the titanate fine particles is treated with a silane coupling agent or a fatty acid, since the surface energy of the surface of the titanate fine particles is decreased, the adhesive force of the toner is reduced, and thus the transfer efficiency can be enhanced.

### Suitable Constituent Components and Suitable Aspects of Toner

Next, suitable constituent components and suitable aspects of the toner according to the present disclosure will be described.

### Binder Resin

The toner particles contain a binder resin.

The binder resin is required to contain 50% by mass or greater of the polyester A as described above and preferably 70% by mass or greater of the polyester A from the viewpoint that the fixability is enhanced, and an interaction between the binder resin and the titanate fine particles is increased so that the transferability in a low-temperature and low-humidity environment is also enhanced.

Further, the binder resin may contain a resin other than the polyester A, such as a styrene acrylic resin, an epoxy resin, polyester, polyurethane, polyamide, a cellulose resin, polyether, and mixed resins and composite resins thereof.

### Polyester A

As described above, the polyester A contains 90% by mole or greater of an isophthalic acid unit Uᵢₛₒ with respect to the amount of all units derived from an acid component.

### The Polyester a can be Amorphous Polyester.

The polyester A may have an isophthalic acid unit as an essential component. The polyester can be obtained by selecting suitable ones from among a polycarboxylic acid, a polyhydric alcohol, and a hydroxycarboxylic acid, combining these, and synthesizing these using a known method such as a transesterification method or a polycondensation method. The polyester can contain a condensation polymer of a dicarboxylic acid and a diol.

The polycarboxylic acid is a compound containing two or more carboxy groups in a molecule. Among examples of the polycarboxylic acid, a dicarboxylic acid is a compound containing two carboxy groups in one molecule and is suitably used.

Examples of the dicarboxylic acid include oxalic acid, succinic acid, glutaric acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-carboxylic acid, hexahydroterephthalic acid, malonic acid, pimelic acid, suberic acid, phthalic acid, isophthalic acid, terephthalic acid, tetrachlorophthalic acid, chlorophthalic acid, nitrophthalic acid, p-carboxyphenylacetic acid, p-phenylenediacetic acid, m-phenylenediacetic acid, o-phenylenediacetic acid, diphenylacetic acid, diphenyl-p,p′-dicarboxylic acid, naphthalene-1,4-dicarboxylic acid, naphthalene-1,5-dicarboxylic acid, naphthalene-2,6-dicarboxylic acid, anthracenedicarboxylic acid, and cyclohexanedicarboxylic acid.

Further, examples of the polycarboxylic acid other than the dicarboxylic acid include trimellitic acid, trimesic acid, pyromellitic acid, naphthalenetricarboxylic acid, naphthalenetetracarboxylic acid, pyrenetricarboxylic acid, pyrenetetracarboxylic acid, itaconic acid, glutaconic acid, n-dodecylsuccinic acid, n-dodecenylsuccinic acid, isododecylsuccinic acid, isododecenylsuccinic acid, n-octylsuccinic acid, and n-octenylsuccinic acid. There may be used alone or in combination of two or more kinds thereof.

The polyol is a compound containing two or more hydroxyl groups in one molecule. Among examples of the polyol, the diol is a compound containing two hydroxy groups in one molecule.

Specific examples of the polyol include ethylene glycol, diethylene glycol, triethylene glycol, 1,2-propanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, 1,14-eicosanedecanediol, dipropylene glycol, polyethylene glycol, polypropylene glycol, polytetramethylene ether glycol, 1,4-cyclohexanediol, 1,4-cyclohexanedimethanol, 1,4-butenediol, neopentyl glycol, polytetramethylene glycol, hydrogenated bisphenol A, bisphenol A, bisphenol F, bisphenol S, and alkylene oxide (ethylene oxide, propylene oxide, and butylene oxide) adducts of the above-described bisphenols.

Among these, alkylene glycol having 2 or more and 12 or less carbon atoms and alkylene oxide adducts of bisphenols are suitable, and combinations of alkylene oxide adducts of bisphenols and alkylene glycol having 2 or more and 12 or less carbon atoms are particularly suitable. Examples of the alkylene oxide adduct of bisphenol A include compounds represented by Formula (A).

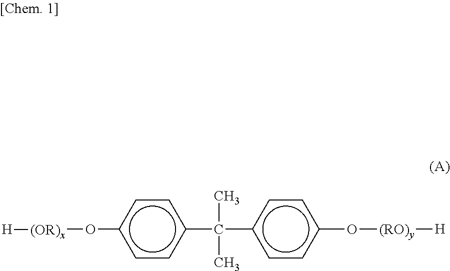

(In Formula (A), R's each independently represent an ethylene group or a propylene group, x and y each represent an integer of 0 or greater, and an average value of x+y is 0 or greater and 10 or less.)

The alkylene oxide adduct of bisphenol A is suitably a propylene oxide adduct and/or an ethylene oxide adduct of bisphenol A and more suitably a propylene oxide adduct. Further, the average value of x+y is preferably 1 or greater and 5 or less.

Examples of the tri- or higher hydric alcohol include glycerin, trimethylolethane, trimethylolpropane, pentaerythritol, hexamethylolmelamine, hexaethylolmelamine, tetramethylol benzoguanamine, tetraethylol benzoguanamine, sorbitol, trisphenol PA, phenol novolac, cresol novolac, and alkylene oxide adducts of the above-described tri- or higher valent polyphenols. These may be used alone or in combination of two or more kinds thereof.

The acid value of the polyester A is preferably 4.0 mgKOH/g or greater and 10.0 mgKOH/g or less.

### Release Agent

In the present disclosure, the toner can be formed of a known release agent.

Specific examples thereof include petroleum-based waxes such as paraffin wax, microcrystalline wax, and petrolatum, and derivatives thereof, montan waxes and derivatives thereof, hydrocarbon waxes obtained by using the Fischer-Tropsch method and derivatives thereof, polyolefin waxes such as polyethylene and derivatives thereof, and natural waxes such as carnauba wax and candelilla wax and derivatives thereof, and the derivatives include oxides, block copolymers with vinyl monomers, and graft modified products.

Further, examples of the waxes include alcohols such as higher aliphatic alcohol; fatty acids such as stearic acid and palmitic acid, acid amides, esters, and ketones thereof; hydrogenated castor oil and derivatives thereof, vegetable waxes, and animal waxes. These may be used alone or in combination.

Among these, polyolefin, hydrocarbon wax obtained by using the Fischer-Tropsch method, or petroleum-based wax can be suitable used from the viewpoint that the developability and the transferability tend to be improved. Further, an antioxidant may be added to these waxes in a range where the effects of the toner are not affected. Further, from the viewpoints of the phase separation properties with respect to the binder resin and the crystallization temperature, suitable examples thereof include higher fatty acid esters such as behenyl behenate and dibehenyl sebacate.

The content of the release agent is preferably 1.0 parts by mass or greater and 30.0 parts by mass or less with respect to 100.0 parts by mass of the binder resin.

The melting point of the release agent is preferably 30° C. or higher and 120° C. or lower and more preferably 60° C. or higher and 100° C. or lower. In a case where a release agent exhibiting the above-described thermal properties is used, a release effect is efficiently exhibited, and a wider fixing region is ensured.

### Plasticizer

The toner particles may contain a crystalline plasticizer for improving sharp melt properties. The plasticizer is not particularly limited, and known plasticizers used in toners as described below can be used.

Specific examples of the plasticizer include esters of monohydric alcohol and aliphatic carboxylic acid, such as behenyl behenate, stearyl stearate, and palmityl palmitate, or esters of carboxylic acid and aliphatic alcohol; esters of dihydric alcohol and aliphatic carboxylic acid, such as ethylene glycol distearate, dibehenyl sebacate, and hexanediol dibehenate, or esters of carboxylic acid and aliphatic alcohol; esters of trihydric alcohol and aliphatic carboxylic acid, such as glycerin tribehenate, or esters of trihydric carboxylic acid and aliphatic alcohol; esters of tetrahydric alcohol and aliphatic carboxylic acid, such as pentaerythritol tetrastearate and pentaerythritol tetrapalmitate, or esters of tetrahydric carboxylic acid and aliphatic alcohol; esters of hexahydric alcohol and aliphatic carboxylic acid, such as dipentaerythritol hexastearate and dipentaerythritol palmitate, or esters of hexahydric carboxylic acid and aliphatic alcohol; esters of polyhydric alcohol and aliphatic carboxylic acid, such as polyglycerin behenate, or esters of polycarboxylic acid and aliphatic alcohol; and natural ester waxes such as carnauba wax and rice wax. These may be used alone or in combination.

### Crystalline Polyester

The toner particles can contain crystalline polyester as a part of the binder resin. The crystalline polyester can be a condensation polymer of a monomer containing an aliphatic diol and/or an aliphatic dicarboxylic acid. Further, the crystalline polyester denotes polyester having a clear melting point as measured using a differential scanning calorimeter (DSC).

The crystalline polyester may have an aliphatic diol unit having 2 or more and 12 or less carbon atoms (more preferably 6 or more and 12 or less carbon atoms) and/or an aliphatic dicarboxylic acid unit having 2 or more and 12 or less carbon atoms (more preferably 6 or more and 12 or less carbon atoms).

The crystalline polyester having such a structure can be suitably used from the viewpoint that the dispersibility of the crystalline polyester between the toner particles is enhanced so that the irregularities in wet spreadability between the toner particles during fixation can be suppressed, and thus the low-temperature fixability is enhanced.

Examples of the aliphatic diol having 2 or more and 12 or less carbon atoms include compounds such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, and 1,12-dodecanediol. Further, an aliphatic diol having a double bond can also be used. Examples of the aliphatic diol having a double bond include compounds such as 2-butene-1,4-diol, 3-hexene-1,6-diol, and 4-octene-1,8-diol. Examples of the aliphatic dicarboxylic acid having 2 or more and 12 or less carbon atoms include compounds such as oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, and 1,12-dodecanedicarboxylic acid. Lower alkyl esters or acid anhydrides of these aliphatic dicarboxylic acids can also be used. Among these, sebacic acid, adipic acid, 1,10-decanedicarboxylic acid, and lower alkyl esters and acid anhydrides thereof are suitable. These can be used alone or in the form of a mixture of two or more kinds thereof. Further, an aromatic dicarboxylic acid can also be used. Examples of the aromatic dicarboxylic acid include compounds such as terephthalic acid, isophthalic acid, 2,6-naphthalenedicarboxylic acid, and 4,4′-biphenyldicarboxylic acid. Among these, terephthalic acid is suitable from the viewpoints of availability and ease of forming a polymer having a low melting point.

Further, a dicarboxylic acid having a double bond can also be used. The dicarboxylic acid having a double bond suppresses hot offset during fixation and thus can be suitably used in terms that the entire resin can be crosslinked by using the double bond thereof.

Examples of such a dicarboxylic acid include fumaric acid, maleic acid, 3-hexenedioic acid, 3-octenedioic acid, and lower alkyl esters and acid anhydrides thereof. Among these, fumaric acid and maleic acid are more suitable.

A method of producing the crystalline polyester is not particularly limited, and the crystalline polyester can be produced by a typical polyester polymerization method of reacting a dicarboxylic acid component with a diol component. The crystalline polyester can be produced, for example, by using an appropriate method such as a direct polycondensation method or a transesterification method depending on the kind of monomer.

The peak temperature of the maximum endothermic peak of the crystalline polyester as measured using a differential scanning calorimeter (DSC) is preferably 50.0° C. or higher and 100.0° C. or lower and more preferably 60.0° C. or higher and 90.0° C. or lower from the viewpoint of low-temperature fixability. Further, from the viewpoint of the low-temperature fixability, the acid value of the crystalline polyester is preferably 2 mgKOH/g or greater and 3 mgKOH/g or less. Further, the Mn of the crystalline polyester is preferably 10,000 or greater and 14,000 or less. From the viewpoint of the balance between the low-temperature fixability and the transferability, the content of the crystalline polyester in the toner is preferably 3.0% by mass or greater and 30.0% by mass or less.

### Titanate Fine Particles

The toner of the present disclosure contains titanate fine particles. When the toner contains titanate fine particles, the irregularities in the electric charge caused by the isophthalic acid unit can be canceled out by the polarization of the titanate fine particles. Therefore, an increase in the gradient force in a low-temperature and low-humidity environment due to the irregularities in the electric charge caused by the isophthalic acid unit can be suppressed. Further, since the electric field due to the irregularities in the electric charge caused by the isophthalic acid unit and the electric field due to the polarization of the titanate fine particles are inversely oriented, the titanate fine particles during the electrophotographic process can remain at a position close to the isophthalic acid unit, and thus the above-described effects are maintained. Accordingly, the coexistence of the isophthalic acid unit and the titanate fine particles enables a satisfactory print quality to be obtained without losing the transferability even in a case where printing is performed to a certain extent.

The kind of titanate fine particles constituting the titanate fine particles is not particularly limited, and any titanate fine particles can be used. Examples thereof include beryllium titanate fine particles, magnesium titanate fine particles, calcium titanate fine particles, strontium titanate fine particles, barium titanate fine particles, radium titanate fine particles, potassium titanate fine particles, and lead titanate fine particles. Among these, strontium titanate fine particles, calcium titanate fine particles, or barium titanate fine particles can be suitably used from the viewpoint that polarization of the fine particles is likely to occur so that an increase in the gradient force on the surface of the toner can be effectively suppressed, and thus the transferability in a low-temperature and low-humidity environment can be enhanced. Particularly, strontium titanate fine particles are more suitably used from the viewpoint that the property of enhancing the transferability in a low-temperature and low-humidity environment is excellent.

The relative dielectric constant of the titanate fine particles is preferably 100 or greater and 2,000 or less from the viewpoint that polarization of the fine particles is likely to occur so that an increase in the gradient force on the surface of the toner can be effectively suppressed, and thus the transferability in a low-temperature and low-humidity environment can be enhanced.

The titanate fine particles can be used without particularly limiting the particle diameter and the shape thereof, but the number average particle diameter of primary particles is preferably 300 nm or less from the viewpoint that the specific surface area is increased so that the titanate fine particles can efficiently interact with the isophthalic acid unit, and thus the irregularities in the electric charge on the surface of the toner can be suppressed. Further, the number average particle diameter of the primary particles is preferably 30 nm or greater from the viewpoint that the titanate fine particles serve as a spacer so that the contact area between the toner and the latent image bearing member can be reduced, and thus the transferability can be enhanced.

Titanate fine particles that have been surface-treated with a known surface treatment agent may be used as the titanate fine particles. Examples of the surface treatment agent include treatment agents such as fatty acids, fatty acid metal salts, silane coupling agents, and silicone oils. The fatty acid is not particularly limited as long as the fatty acid has a structure in which a hydrocarbon group and a carboxy group are bonded to each other, and a fatty acid in which an alkyl group having 12 or more and 28 or less carbon atoms and a carboxy group are bonded to each other can be used. Further, these metal salts and the like can be used in the same manner as described above.

Examples of the silane coupling agents include n-octyltriethoxysilane, methyltrimethoxysilane, hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchlorosilane, α-chloroethyltrichlorosilane, β-chloroethyltrichlorosilane, chloromethyldimethylchlorosilane, triorganosilylmercaptan, trimethylsilylmercaptan, triorganosilyl acrylate, vinyl dimethyl acetoxy silane, dimethylethoxysilane, dimethyldimethoxysilane, diphenyldiethoxysilane, hexamethyl disiloxane, 1,3-divinyltetramethyldisiloxane, 1,3-diphenyltetramethyldisiloxane, and dimethylpolysiloxane having 2 to 12 siloxane units per molecule and containing one hydroxyl group in each Si unit positioned at the terminals. These can be used alone or in the form of a mixture of two or more kinds thereof.

Examples of the silicone oils include dimethyl silicone oil, methyl phenyl silicone oil, α-methylstyrene-modified silicone oil, chlorophenyl silicone oil, and fluorine-modified silicone oil.

As the surface treatment agent of the titanate fine particles, the above-described treatment agents may also be used alone or in the form of a mixture of two or more kinds thereof. Particularly, in a case where a silane coupling agent or a fatty acid is used as the surface treatment agent of the titanate fine particles, the adhesive force can be suppressed, and thus the transfer efficiency can be enhanced.

### Colorant

The toner particles may contain a colorant. A known pigment or a known dye can be used as the colorant. From the viewpoint of excellent weather resistance, a pigment is suitable as the colorant.

Examples of a cyan-based colorant include a copper phthalocyanine compound and a derivative thereof, an anthraquinone compound, and a base dye lake compound. Specific examples thereof include C.I. Pigment Blue 1, 7, 15, 15:1, 15:2, 15:3, 15:4, 60, 62, and 66.

Examples of a magenta-based colorant include a condensed azo compound, a diketopyrrolopyrrole compound, an anthraquinone compound, a quinacridone compound, a base dye lake compound, a naphthol compound, a benzimidazolone compound, a thioindigo compound, and a perylene compound. Specific examples thereof include C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254, and C.I. Pigment Violet 19.

Examples of a yellow-based colorant include a condensed azo compound, an isoindolinone compound, an anthraquinone compound, an azo metal complex, a methine compound, and an allylamide compound. Specific examples thereof include C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of a black colorant include colorants toned to black using the yellow-based colorant, the magenta-based colorants, and the cyan-based colorants described above, carbon black, and a magnetic material.

These colorants can be used alone or in the form of a mixture, and can also be used as a solid solution. The content of the colorant is preferably 1.0 parts by mass or greater and 20.0 parts by mass or less with respect to 100.0 parts by mass of the binder resin. Further, in a case where a production method carried out in an aqueous medium described below using a magnetic material is employed, a hydrophobic treatment can also be performed for the purpose of allowing the resin to stably contain a magnetic material.

### Charge Control Agent and Charge Control Resin

The toner particles may contain a charge control agent or a charge control resin. As the charge control agent, a known charge control agent can be used, and particularly a charge control agent that has a high triboelectric charging speed and is capable of stably maintaining a constant triboelectric charging amount is suitable. Further, in a case where the toner particles are produced by a suspension polymerization method, a charge control agent that has low polymerization inhibition properties and is substantially free from a solubilized substance in an aqueous medium is particularly suitable.

Examples of a charge control agent that controls the toner to be negatively charged include a monoazo metal compound, an acetylacetone metal compound, an aromatic oxycarboxylic acid-based metal compound, an aromatic dicarboxylic acid-based metal compound, an oxycarboxylic acid-based metal compound, a dicarboxylic acid-based metal compound, an aromatic oxycarboxylic acid, an aromatic monocarboxylic acid, an aromatic polycarboxylic acid, and metal salts thereof, anhydrides, esters, phenol derivatives such as bisphenol, urea derivatives, a metal-containing salicylic acid-based compound, a metal-containing naphthoic acid-based compound, a boron compound, a quaternary ammonium salt, a calixarene, an a charge control resin.

Examples of the charge control resin include a polymer or copolymer containing a sulfonic acid group, a sulfonate group, or a sulfonic acid ester group. The polymer containing a sulfonic acid group, a sulfonate group, or a sulfonic acid ester group is particularly suitably a polymer containing 2% by mass or greater of a sulfonic acid group-containing acrylamide-based monomer or a sulfonic acid group-containing methacrylamide-based monomer and more suitably a polymer containing 5% by mass or greater thereof in terms of the copolymerization ratio.

The charge control resin have a glass transition temperature (Tg) of preferably 35° C. or higher and 90° C. or lower, a peak molecular weight (Mp) of preferably 10,000 or greater and 30,000 or less, and a weight-average molecular weight (Mw) of preferably 25,000 or greater and 50,000 or less. In a case where such a charge control resin is used, suitable triboelectric charge characteristics can be imparted to the toner particles without affecting thermal characteristics required for the toner particles. Further, in a case where the charge control resin contains a sulfonic acid group, for example, the dispersibility of the charge control resin and the dispersibility of a colorant and the like in a polymerizable monomer composition are improved, and the coloring power, the transparency, and the triboelectric charge characteristics can be improved.

These charge control agents or charge control resins may be respectively used alone or in combination of two or more kinds thereof for addition. The amount of the charge control agent or charge control resin to be added is preferably 0.01 parts by mass or greater and 20.0 parts by mass or less and more preferably 0.5 parts by mass or greater and 10.0 parts by mass or less with respect to 100.0 parts by mass of the binder resin.

### Method of Producing Toner

A method of producing the toner is not particularly limited, and the toner can be produced by using a known method such as a pulverization method, a suspension polymerization method, a dissolution suspension method, an emulsion aggregation method, or a dispersion polymerization method. Here, the toner can be produced by the method described below. That is, the toner can be produced by an emulsion aggregation method.

In a case where an emulsion aggregation method is used to produce the toner, the method includes steps (1) to (3) in the following order:
(1) a dispersion step of preparing a binder resin fine particle dispersion liquid containing the binder resin,
(2) an aggregation step of aggregating binder resin fine particles contained in the binder resin fine particle dispersion liquid to form aggregates, and
(3) a fusion step of heating and fusing the aggregates.

Further, the method may further include, in the middle or after the fusion step, steps (4) to (6) in the following order:
(4) a spheronization step of further increasing the temperature and heating the aggregates,
(5) a cooling step of cooling the aggregates at a cooling rate of 0.1° C./sec or greater, and
(6) an annealing step of heating and maintaining the aggregates at a temperature higher than or equal to the crystallization temperature of the binder resin or higher than or equal to the glass transition temperature of the binder resin.

From the viewpoints of easily uniformly dispersing the polyester A in the vicinity of the surface of the toner particles and easily controlling the toner shape, the emulsion aggregation method is suitably used. Hereinafter, the emulsion aggregation method will be described in detail.

### Emulsion Aggregation Method

The emulsion aggregation method is a method of producing toner particles by preliminarily preparing an aqueous dispersion liquid of fine particles formed of a constituent material of toner particles which are relatively small with respect to the target particle diameter, aggregating the fine particles until the particle diameter of the fine particles reach the particle diameter of the toner particles in an aqueous medium, and fusing the resin by being heated or the like.

That is, according to the emulsion aggregation method, the toner particles are produced by performing a dispersion step of preparing a fine particle dispersion liquid formed of a constituent material of toner particles, an aggregation step of aggregating the fine particles formed of the constituent material of the toner particles and controlling the particle diameter until the particle diameter of the particles reaches the particle diameter of the toner particles, a fusion step of performing melt adhesion on the resin contained in the obtained aggregated particles, a spheronization step of heating the particles so that the particles are melted and controlling the surface shape of the toner, and the subsequent steps, which are a cooling step, a metal removal step of separating the obtained toner by filtration to remove excess polyvalent metal ions, a filtering and washing step of washing the toner particles with ion exchange water or the like, and a step of removing the moisture of the washed toner particles to dry the toner particles.

### Step of Preparing Resin Fine Particle Dispersion Liquid (Dispersion Step)

The resin fine particle dispersion liquid can be prepared by a known method, but the present disclosure is not limited thereto. Examples of the known method include an emulsion polymerization method, a self-emulsification method, a phase inversion emulsification method of adding an aqueous medium to a resin solution dissolved in an organic solvent to emulsify the resin, and a forced emulsification method of performing a high-temperature treatment in an aqueous medium to forcibly emulsify the resin without using an organic solvent.

Specifically, the binder resin is dissolved in an organic solvent that can dissolve the resin, and a surfactant and a basic compound are added thereto. In this case, when the binder resin is a crystalline resin having a melting point, the resin may be dissolved by being heated at the melting point or higher. Next, an aqueous medium is slowly added to the mixture while the mixture is stirred with a homogenizer or the like, to precipitate the resin fine particles. Thereafter, the solvent is removed by heating the mixture or reducing the pressure, thereby preparing an aqueous dispersion liquid of the resin fine particles. Any organic solvent can be used as the organic solvent used for dissolving the resin as long as the organic solvent can dissolve the resin, but it is desirable to use an organic solvent that forms a homogeneous phase with water, such as toluene, from the viewpoint of suppressing generation of coarse powder.

The surfactant used for the emulsification is not particularly limited, and examples thereof include an anionic surfactant such as a sulfuric acid ester salt-based surfactant, a sulfonate-based surfactant, a carbonate-based surfactant, a phosphoric acid ester-based surfactant, or a soap-based surfactant; a cationic surfactant such as an amine salt type surfactant or a quaternary ammonium salt type surfactant; and a nonionic surfactant such as a polyethylene glycol-based surfactant, an alkylphenol ethylene oxide adduct-based surfactant, or a polyhydric alcohol-based surfactant. The surfactant may be used alone or in combination of two or more kinds thereof.

Examples of the basic compound used in the dispersion step include an inorganic base such as sodium hydroxide or potassium hydroxide; and an organic base such as ammonia, triethylamine, trimethylamine, dimethylaminoethanol, or diethylaminoethanol. The basic compound may be used alone or in combination of two or more kinds thereof.

Further, the 50% particle diameter (D50) of fine particles of the binder resin based on volume distribution in the aqueous dispersion liquid of resin fine particles is preferably 0.05 μm or greater and 1.0 μm or less and more preferably 0.05 μm or greater and 0.4 μm or less. Toner particles having an appropriate volume average particle diameter of 3 μm or greater and 10 μm or less are easily obtained by adjusting the 50% particle diameter (D50) thereof based on volume distribution to be in the above-described ranges.

In addition, the 50% particle diameter (D50) of particles based on volume distribution is measured using a dynamic light scattering particle size distribution meter NANOTRAC UPA-EX150 (manufactured by Nikkiso Co., Ltd.).

### Colorant Fine Particle Dispersion Liquid

A colorant fine particle distribution liquid may be used as necessary. The colorant fine particle distribution liquid can be prepared by a known method described below, but the present disclosure is not limited thereto. The colorant fine particle distribution liquid can be prepared by mixing a colorant, an aqueous medium, and a dispersant using a known mixer such as a stirrer, an emulsifier, or a disperser. A known dispersant such as a surfactant or a polymer dispersant can be used as the dispersant used here.

Both dispersants, the surfactant and the polymer dispersant, can be removed in a washing step described below, but the surfactant is suitable from the viewpoint of washing efficiency.

Examples of the surfactant include an anionic surfactant such as a sulfuric acid ester salt-based surfactant, a sulfonate-based surfactant, a phosphoric acid ester-based surfactant, or a soap-based surfactant; a cationic surfactant such as an amine salt type surfactant or a quaternary ammonium salt type surfactant; and a nonionic surfactant such as a polyethylene glycol-based surfactant, an alkylphenol ethylene oxide adduct-based surfactant, or a polyhydric alcohol-based surfactant.

Among these, a nonionic surfactant or an anionic surfactant is suitable. Further, a nonionic surfactant and an anionic surfactant may be used in combination. The surfactant may be used alone or in combination of two or more kinds thereof. The concentration of the surfactant in an aqueous medium is preferably in a range of 0.5% by mass to 5% by mass.

The content of the colorant fine particles in the colorant fine particle dispersion liquid is not particularly limited, but is preferably 1% by mass or greater and 30% by mass or less with respect to the total mass of the colorant fine particle dispersion liquid.

In the dispersed particle diameter of the colorant fine particle in the aqueous dispersion liquid of the colorant, the 50% particle diameter (D50) based on the volume distribution is preferably 0.5 μm or less from the viewpoint of the dispersibility of the colorant in the toner to be finally obtained. Further, a 90% particle diameter (D90) based on the volume distribution is preferably 2 μm or less for the same reason. In addition, the dispersed particle diameter of the colorant fine particles dispersed in the aqueous medium is measured using a dynamic light scattering particle size distribution meter (NANOTRAC UPA-EX150, manufactured by Nikkiso Co., Ltd.).

Examples of the mixer such as a known stirrer, emulsifier, or disperser used when the colorant is dispersed in the aqueous medium include an ultrasonic homogenizer, a jet mill, a pressure homogenizer, a colloid mill, a ball mill, a sand mill, and a paint shaker. These may be used alone or in combination.

### Release Agent (Aliphatic Hydrocarbon Compound) Fine Particle Dispersion Liquid

A release agent fine particle dispersion liquid may be used as necessary. The release agent fine particle dispersion liquid can be prepared by a known method described below, but the present disclosure is not limited thereto.

The release agent fine particle dispersion liquid can be prepared by adding a release agent to an aqueous medium containing a surfactant, heating the mixture at a temperature higher than or equal to the melting point of the release agent, dispersing the release agent in the form of particles using a homogenizer (for example, “CLEARMIX W-MOTION”, manufactured by M Technique Co., Ltd.) having a strong shearing ability or a pressure ejection type disperser (for example, “GAULIN HOMOGENIZER”, manufactured by Gaulin Corporation), and cooling the mixture at a temperature lower than the melting point of the release agent.

In the dispersed particle diameter of the release agent fine particle dispersion liquid in the aqueous dispersion liquid of the release agent, the 50% particle diameter (D50) based on the volume distribution is preferably 0.03 μm or greater and 1.0 μm or less and more preferably 0.1 μm or greater and 0.5 μm or less. Further, desirably no coarse particles having a particle diameter of 1 μm or greater are present.

In a case where the dispersed particle diameter of the release agent fine particle dispersion liquid is in the above-described ranges, the release agent can be present in a state of being finely dispersed in the toner, a bleeding effect during fixation can be maximized, and satisfactory separation properties can be obtained. Further, the dispersed particle diameter of the release agent fine particle dispersion liquid dispersed in the aqueous medium can be measured using a dynamic light scattering particle size distribution meter NANOTRAC UPA-EX150 (manufactured by Nikkiso Co., Ltd.).

### Mixing Step

In the mixing step, a mixed solution is prepared by mixing the resin fine particle dispersion liquid with at least one of the release agent fine particle dispersion liquid and the colorant fine particle dispersion liquid as necessary. The mixed solution can be prepared by using a known mixing device such as a homogenizer or a mixer.

### Step of Forming Aggregated Particles (Aggregation Step)

In the aggregation step, the fine particles contained in the mixed solution prepared in the mixing step are aggregated to form aggregates with a target particle diameter. Here, an aggregating agent is added thereto and mixed into the mixture, and the mixture is appropriately subjected to heating and mechanical power as necessary to form aggregates in which the resin fine particles and at least one of the release agent fine particles and the colorant fine particles are aggregated.

Examples of the aggregating agent include monovalent metal salts such as thorium and potassium, divalent metal salts such as calcium and magnesium, trivalent metal salts such as iron and aluminum, and alcohols such as methanol, ethanol, and propanol. An aggregating agent containing a di- or higher valent metal element that has a high aggregation force and is capable of performing aggregation when added in a small amount can be used.

Specific examples of the aggregating agent include divalent inorganic metal salts such as calcium chloride, calcium nitrate, magnesium chloride, magnesium sulfate, and zinc chloride, trivalent metal salts such as iron (III) chloride, iron (III) sulfate, aluminum sulfate, and aluminum chloride, and inorganic metal salt polymers such as polyaluminum chloride, polyaluminum hydroxide, ferric polysulfate, and calcium polysulfide, but the present disclosure is not limited thereto. These may be used alone or in combination of two or more kinds thereof. From the viewpoint of controlling the amount of the aluminum element in the toner particles, aluminum metal salts are suitably used. Further, an acid can also be added so that the pH is decreased and the particles are softly aggregated, and sulfuric acid, nitric acid, or the like can be used.

The aggregating agent may be added to the mixed solution in any form of dry powder or an aqueous solution dissolved in an aqueous medium, but the aggregating agent can be added in the form of an aqueous solution in order to uniformly aggregate the particles. Further, the aggregating agent can be added to and mixed into the mixed solution at a temperature lower than or equal to the glass transition temperature or the melting point of the resin contained in the mixed solution. When the aggregating agent is mixed into the mixed solution under the above-described temperature conditions, relatively uniform aggregation proceeds. The aggregating agent can be mixed into the mixed solution using a known mixing device such as a homogenizer or a mixer. The aggregation step is a step of forming aggregates having a toner particle size in the aqueous medium. The volume average particle diameter of the aggregates produced in the aggregation step is preferably 3 μm or greater and 10 μm or less. The volume average particle diameter can be measured by a coulter method using a particle size distribution analyzer (COULTER Multisizer III: manufactured by Beckman Coulter, Inc.).

### Step of Obtaining Dispersion Liquid Containing Toner Particles (Fusion Step)

In the fusion step, first, the aggregation is stopped while the dispersion liquid containing the aggregates obtained in the aggregation step is stirred in the same manner as in the aggregation step. The aggregation is stopped by adding an aggregation stopping agent such as a base, a chelate compound, or an inorganic salt compound such as sodium chloride, which can adjust the pH.

The dispersed state of the aggregated particles in the dispersion liquid is stabilized by the action of the aggregation stopping agent, the mixed solution is heated at a temperature higher than or equal to the glass transition temperature or the melting point of the binder resin to fuse the aggregated particles, and thus the particles having a desired particle diameter are prepared.

Further, the 50% particle diameter (D50) based on volume distribution of the toner particles is preferably 3 μm or greater and 10 μm or less.

### Step of Obtaining Desired Surface Shape of Toner (Spheronization Step)

The spheronization step of further increasing the temperature and maintaining the temperature until the toner particles have a desired circularity or surface shape can be performed during or after the fusion step. The specific temperature of the spheronization step is, for example, preferably 90° C. or higher and more preferably 92° C. or higher, and preferably 95° C. or lower. The heating time in the spheronization step is, for example, 3 hours or longer, 5 hours or longer, or 8 hours or longer.

### Cooling Step

The cooling step of decreasing the temperature of the dispersion liquid containing the obtained toner particles to a temperature lower than the crystallization temperature or the glass transition temperature of the binder resin can be performed by controlling the cooling rate after the spheronization step. Since formation of unevenness on the surface of the toner particles accompanied by a change in volume, such as expansion or contraction, of the material in the toner particles can be suppressed by performing the cooling step. Specifically, the cooling rate is 0.1° C./sec or greater, preferably 0.5° C./sec or greater, more preferably 2° C./sec or greater, and still more preferably 4° C./sec or greater.

### Annealing Step

An annealing step of heating the dispersion liquid at a temperature higher than or equal to the crystallization temperature or higher than or equal to the glass transition temperature of the binder resin or at a temperature lower than or equal to the crystallization temperature of a release agent in a case where the dispersion liquid contains a release agent and maintaining the temperature can be performed after the cooling step. Since the change in volume can be further suppressed by performing the annealing step, generation of recesses in the surface of the toner particles can be suppressed. Therefore, a desired circularity or a desired surface shape obtained by performing the cooling step can be maintained. Specifically, the annealing temperature is 45° C. or higher and 75° C. or lower, preferably 50° C. or higher and 70° C. or lower, and more preferably 55° C. or higher and 65° C. or lower. The heat treatment time of the annealing step is, for example, within 5 hours and preferably in a range of 2 to 3 hours.

### Post-Treatment Step

In the method of producing the toner, post-treatment steps such as a washing step, a solid-liquid separation step, a drying step, and the like may be performed, and toner particles in a dried state can be obtained by performing the post-treatment steps.

### External Addition Step

The titanate fine particles are externally added to the toner particles obtained as described above. Other known fine particles of the related art may be used in combination as necessary.

The amount of the titanate fine particles to be added may be 0.01 parts by mass or greater and 5.00 parts by mass or less and is preferably 0.1 parts by mass or greater and 1.0 parts by mass or less with respect to 100 parts by mass of the toner particles from the viewpoint of achieving both the fixability and the transferability of the toner at a high level.

The toner of the present disclosure may contain other external additives in addition to the titanate fine particles.

The other external additives are not particularly limited, and known external additives of the related art can be used alone or in combination of a plurality of kinds thereof. Further, the particle diameter of the external additive is not particularly limited, and the external additives with different particle diameters may be used in combination. Specific examples thereof include raw silica fine particles such as wet-process silica and dry-process silica, surface-treated silica fine particles obtained by performing a surface treatment on such raw silica fine particles with a treatment agent such as a silane coupling agent, a titanium coupling agent, or a silicone oil, and resin fine particles such as vinylidene fluoride fine particles and polytetrafluoroethylene fine particles. The surface-treated silica can be used in combination with the titanate fine particles as the external additive in order to enhance the transferability.

The content of the other external additives is preferably 0.1 parts by mass or greater and 5.0 parts by mass or less with respect to 100.0 parts by mass of the toner particles.

### Method of Measuring Physical Properties

Next, a method of measuring each physical property according to the present disclosure will be described.

### Method of Isolating Toner Particles and Titanate Fine Particles and Method of Measuring Content of Titanate Fine Particles in Toner

0.50 g of Triton-X100 (manufactured by Kishida Chemical Co., Ltd.) is added to 100 g of ion exchange water to prepare a dispersion medium.
(1) 1.00 g of the toner is precisely weighed in a vial, the above-described dispersion medium is added thereto such that the total amount of the mixture reaches 10.00 g, and the mixture is allowed to stand for 24 hours to prepare a sample liquid.
2) The sample liquid is subjected to an ultrasonic homogenizer treatment to release the external additive from the toner, and the external additive is dispersed in a dispersion medium.
Ultrasonic treatment device: ultrasonic homogenizer VP-050 (manufactured by TAITEC CORPORATION)
Microchip: step type microchip, tip diameter: 2 mm
Tip position of microchip: central portion of glass vial at height of 5 mm from bottom surface of vial
Conditions for ultrasonic waves: intensity of 30% for 180 minutes, here, ultrasonic waves are applied while the vial is cooled with ice water so that the dispersion liquid is not heated
(3) The toner particles in the sample liquid are separated from the dispersion medium in which the external additive is dispersed by suction filtration (10 μm membrane filter) (filtrate).
(4) The filtered toner particles are recovered, the dispersion medium is added thereto again so that the total amount of the mixture reaches 10.00 g, the above-described processes (2) and (3) are repeated ten times, and the entire filtrate is recovered.
(5) In a case where other external additives have been externally added, the recovered filtrate is centrifuged using a centrifuge to separate the other external additives so that the titanate fine particles are recovered.
(6) The recovered titanate fine particles are sufficiently dried at 60° C. for 24 hours using a vacuum dryer to isolate the dried titanate fine particles.

The mass of the titanate fine particles contained in 1.00 g of the toner is determined by measuring the mass of the dried titanate fine particles. Further, a value obtained by multiplying the obtained mass by 100 is defined as the content (% by mass) of the titanate fine particles in the toner.

### Method of Isolating Toner Particles

In the item (4) of the method of isolating the toner particles and the titanate fine particles and the method of measuring the content of the titanate fine particles in the toner, the toner particles obtained by repeatedly performing filtration a total of ten times are recovered and sufficiently dried at 45° C. for 24 hours, thereby isolating the toner particles.

Method of Isolating Binder Resin from Toner Particles

100 mg of the toner particles are dissolved in 3 mL of chloroform. Next, the solution is subjected to suction filtration with a syringe equipped with a sample treatment filter (pore size of 0.2 μm or greater and 0.5 μm or less, for example, using “MYSHORIDISC H-25-2” (manufactured by Tosoh Corporation) to remove insoluble matter. Soluble matter is introduced to a preparative HPLC (device: LC-9130 NEXT, manufactured by Japan Analytical Industry Co., Ltd., preparative column [60 cm], exclusion limit: 20,000 and 70,000, two columns are connected), and a chloroform eluent is sent. When a peak can be confirmed in the display of a chromatograph to be obtained, the retention time at which the molecular weight of a monodisperse polystyrene standard sample is 2,000 or greater is dispensed.

The solution of the obtained fraction is dried and solidified so that the binder resin is dispensed by being separated from the release agent.

### Composition Analysis of Plurality of Components (Polyester a and Crystalline Polyester)

A chloroform soluble matter of the dispensed binder resin is used as a sample. The sample is prepared such that the concentration of the toner particles in chloroform reaches 0.1% by mass, and the solution is filtered through a PTFE filter having a pore size of 0.45 μm and used in the measurement. The conditions for gradient polymer LC measurement are as follows.
Device: ULTIMATE 3000 (manufactured by Thermo Fisher Scientific Inc.)
Mobile phase: A chloroform (HPLC), B acetonitrile (HPLC)
Gradient: 2 min (A/B=0/100)→25 min (A/B=100/0)
(Further, the gradient in change of mobile phase is set to be linear.)
Flow rate: 1.0 mL/min
Injection: 0.1% by mass×20 μL
Column: Tosoh TSKgel ODS (4.6 mmϕ×150 mm×5 μm)
Column temperature: 40° C.
Detector: Corona charged particle detector (Corona-CAD) (manufactured by Thermo Fisher Scientific Inc.)

The polyester A is dispensed at a time (7 minutes to 9 minutes) corresponding to the polyester A. Further, the crystalline polyester is dispensed at a time (13 minutes to 15 minutes) corresponding to the crystalline polyester.

In the dispensation, required amounts of chloroform/acetonitrile solutions are collected for each of the polyester A and the crystalline polyester, dried, concentrated, and used as samples of the polyester A and the crystalline polyester.

The composition ratio and the mass ratio between the samples of the polyester A and the crystalline polyester by nuclear magnetic resonance spectrometry (NMR) as described below.

1 mL of deuterated chloroform is added to 20 mg of the samples (the polyester A and the crystalline polyester), and NMR spectrum of the protons in the dissolved resins is measured. The molar ratio and the mass ratio of each monomer are calculated from the obtained NMR spectrum by assuming that the minimum unit sandwiched between ester bonds is a structure derived from the monomer (an acid component or an alcohol component), and the content proportion of each monomer unit can be determined.

The device and the measurement conditions described below can be used for nuclear magnetic resonance spectrometry (NMR).
NMR device: RESONANCE ECX 500 (manufactured by JEOL Ltd.)
Observed nucleus: proton
Measurement mode: single pulse
   Method of Quantifying Contents of Uᵢₛₒ, U_{EO}, and U_{PO} in Polyester a by NMR Measurement

Identification of component of polyester A and measurement of molar ratio and mass ratio by nuclear resonance spectrometry (NMR)

1 mL of deuterated chloroform is added to 20 mg of the obtained polyester A, and the NMR spectrum of protons of the dissolved polyester A is measured. The molar ratio and the mass ratio of each monomer are calculated from the obtained NMR spectrum.

For example, the composition ratio and the mass ratio can be calculated based on the following peaks (chemical shift values, number of protons).
Unit derived from isophthalic acid: 7.5 ppm (1), 8.2 ppm (2), 8.7 ppm (1)
Unit derived from terephthalic acid: 8.1 ppm (4)
Unit derived from ethylene oxide adduct of bisphenol A: 1.6 ppm (6), 4.3 ppm (4), 4.7 ppm (4), 6.8 ppm (4), 7.1 ppm (4)
Unit derived from propylene oxide adduct of bisphenol A: 1.5 ppm (6), 1.6 ppm (6), 4.1 ppm (4), 5.5 ppm (2), 6.8 ppm (4), 7.1 ppm (4)
Unit derived from ethylene glycol: 4.3 ppm (4)
NMR device: JEOL RESONANCE ECX500

Observed nucleus: proton, measurement mode: simple pulse, Reference peak: TMS

The content (% by mole) of the isophthalic acid unit Uᵢₛₒ with respect to the amount of all units derived from an acid component is determined by the NMR analysis. Further, the total content proportion (% by mole) of the units UFO and U_{PO} with respect to the amount of all units derived from an alcohol component is determined. Further, the content proportion (% by mole) of U_{EO} with respect to the total content proportion of the units U_{EO} and U_{PO} is determined.

### Method of Measuring Weight-Average Molecular Weight Mw and Number Average Molecular Weight Mn

The molecular weights of samples such as the polyester A, the crystalline polyester, and styrene acryl are measured by gel permeation chromatography (GPC) as described below.

First, the samples are dissolved in tetrahydrofuran (THF). The polyester A and the styrene acryl are dissolved in THF at room temperature over 24 hours. Further, the crystalline polyester is dissolved in THE after THE is heated to 40° C., and the solution is allowed to stand for 24 hours.

Each solution in which each sample is dissolved is filtered through a solvent-resistant membrane filter “MYSHORIDISC” (manufactured by Tosoh Corporation) having a pore size of 0.2 μm to obtain a sample solution. Further, the sample solution is prepared such that the concentration of the component soluble in THE is adjusted to 0.8% by mass. The measurement is performed using this sample solution under the following conditions.
Device: HLC8120GPC (detector: RI) manufactured by Tosoh Corporation)·
   Column: seven units of Shodex KF-801, 802, 803, 804, 805, 806, and 807 (manufactured by Showa Denko K.K.)
Eluent: tetrahydrofuran (THF)
   Flow rate: 1.0 mL/min
   Oven temperature: 40.0° C.
   Sample injection volume: 0.10 mL

The molecular weight of each sample is calculated by using a molecular weight calibration curve prepared with a standard polystyrene resin (for example, trade name “TSK Standard Polystyrene F-850, F-450, F-288, F-128, F-80, F-40, F-20, F-10, F-4, F-2, F-1, A-5000, A-2500, A-1000, and A-500”, manufactured by Tosoh Corporation).

### Method of Measuring Melting Point

The melting points of samples such as the crystalline polyester, the release agent, and the plasticizer are measured using a differential scanning calorimeter (DSC) Q2000 (manufactured by TA Instruments).
Temperature increasing rate: 10° C./min
Measurement start temperature: 20° C.
Measurement end temperature: 180° C.

The melting points of indium and zinc are used for correcting the temperature of a device detection unit, and heat of fusion of indium is used for correcting the heat quantity.

Specifically, about 5 mg of the sample is precisely weighed and placed in an aluminum pan, and the measurement is performed once. An empty aluminum pan is used as a reference. Here, the peak temperature of the maximum endothermic peak is defined as the melting point.

### Measurement of Glass Transition Temperature Tg

The glass transition temperature Tg is measured by using a differential scanning calorimeter “Q2000” (manufactured by TA Instruments) in conformity with ASTM D3418-82. The melting points of indium and zinc are used for correcting the temperature of a device detection unit, and heat of fusion of indium is used for correcting the heat quantity. Specifically, about 2 mg of the sample is precisely weighed and placed in an aluminum pan, an empty aluminum pan is used as a reference, and the measurement is performed in a measurement temperature range of −10° C. to 200° C. at a temperature increasing rate of 10° C./min. Further, in the measurement, the temperature is increased once to 200° C., decreased to −10° C., and then increased again. A change in specific heat is obtained in a temperature range of 30° C. to 100° C. in the second temperature increasing process. The intersection point of a line between midpoints of baselines before and after the change in specific heat occurs and a differential thermal curve is defined as the glass transition temperature Tg.

### Measurement of Acid Value

The acid value is the number of milligrams of potassium hydroxide required to neutralize the acid contained in 1 g of the sample.

The acid value in the present disclosure is measured in conformity with JIS K 0070-1992, and specifically, the acid value is measured by the following procedures.

Titration is performed using a 0.1 mol/l potassium hydroxide ethyl alcohol solution (manufactured by Kishida Chemical Co., Ltd.). The factor of the potassium hydroxide ethyl alcohol solution can be determined by using a potentiometric titration device (potentiometric titration measuring device At-510, manufactured by Kyoto Electronics Manufacturing Co., Ltd.). 100 mL of 0.100 mol/L hydrochloric acid is placed in a 250 mL tall beaker and titrated with the potassium hydroxide ethyl alcohol solution, and the acid value is determined from the amount of the potassium hydroxide ethyl alcohol solution required for neutralization. Hydrochloric acid prepared in conformity with JIS K 8001-1998 is used as the 0.100 mol/l hydrochloric acid.

The conditions for measuring the acid value are described below.
Titration device: potentiometric titration device AT-510 (manufactured by Kyoto Electronics Manufacturing Co., Ltd.)
Electrode: composite glass electrode double junction type (manufactured by Kyoto Electronics Manufacturing Co., Ltd.)
Software for controlling titration device: AT-WIN
Titration analysis software: Tview

The titration parameter and the control parameter during the titration are determined as follows.
Titration parameter
Titration mode: blank titration
Titration style: total amount titration
Maximum titer: 20 mL
Waiting time before titration: 30 seconds
Titration direction: automatic
Control parameter
End point determination potential: 30 dE
End point determination potential value: 50 dE/dmL
End point detection determination: not set
Control speed mode: standard
Gain: 1
Data collection potential: 4 mV
Data collection titer: 0.1 mL
Main test: 0.100 g of the measurement sample is precisely weighed in a 250 mL tall beaker, and 150 mL of a mixed solution of toluene and ethanol at a mixing ratio of 3:1 is added thereto to dissolve the sample over 1 hour. The titration is performed using the potassium hydroxide ethyl alcohol solution with the potentiometric titration device. Blank test: Titration is performed by carrying out the same operation as described above except that the sample is not used (that is, only the mixed solution of toluene and ethanol at a mixing ratio of 3:1 is used). The obtained results are substituted into the following equation to calculate the acid value.

$$A = [ ( C - B ) \times f \times 5.6 \; 11 ] / S$$

(In the equation, A represents the acid value (mgKOH/g), B represents the amount (mL) of the potassium hydroxide ethyl alcohol solution to be added in the black test, C represents the amount (mL) of the potassium hydroxide ethyl alcohol solution to be added in the main test, f represents the factor of the potassium hydroxide ethyl alcohol solution, and S represents the sample (g).)

### Method of Measuring Average Circularity of Toner (Particles)

The average circularity of the toner or the toner particles is measured using a flow type particle image analyzer “FPIA-3000” (manufactured by Sysmex Corporation) under measurement and analysis conditions during the calibration work.

An appropriate amount of alkylbenzene sulfonate serving as a surfactant is added to 20 mL of ion exchange water as a dispersant, 0.02 g of a measurement sample is added thereto, and a dispersion treatment is performed on the mixture for 2 minutes using a table top ultrasonic cleaner disperser (trade name: VS-150, manufactured by VELVO-CLEAR) at an oscillation frequency of 50 kHz and an electrical output of 150 watts to obtain a dispersion liquid for measurement. In this case, the dispersion liquid is appropriately cooled such that the temperature of the dispersion liquid is 10° C. or higher and 40° C. or lower.

The measurement is performed by using the flow type particle image analyzer equipped with a standard objective lens (10 times) and a particle sheath “PSE-900A” (manufactured by Sysmex Corporation) as a sheath liquid. The dispersion liquid prepared by the above-described procedures is introduced to the flow type particle image analyzer, 3,000 toner particles are measured in a total count mode and an HPF measurement mode, the binarization threshold value during particle analysis is set to 85%, the particle diameter for analysis is limited to an equivalent circle diameter of 1.98 μm or greater and 19.92 μm or less, thereby determining the average circularity of the toner particles.

In the measurement, automatic focus adjustment is performed using standard latex particles (for example, 5100A (trade name, manufactured by Duke Scientific Corporation) diluted with ion exchange water) before the start of measurement. Thereafter, focus adjustment can be performed every two hours from the start of measurement.

### Method of Measuring Weight-Average Particle Diameter (D4) of Toner

The weight-average particle diameter (D4) and the number average particle diameter (D1) of the toner are measured by 25,000 effective measuring channels using a precision particle size distribution measuring device “COULTER COUNTER Multisizer 3” (registered trademark, manufactured by Beckman Coulter, Inc.) provided with an aperture tube having a diameter of 100 μm by an aperture impedance method and dedicated software “BECKMAN COULTER Multisizer 3 Version 3.51” (manufactured by Beckman Coulter, Inc.) attached to the device for setting measurement conditions and analyzing measurement data, and calculated by analyzing measurement data.

An electrolyte solution obtained by dissolving special grade sodium chloride in ion exchange water and adjusting the concentration thereof to about 1% by mass, for example, “ISOTON II” (manufactured by Beckman Coulter, Inc.) can be used as the electrolyte solution used for the measurement.

In addition, dedicated software is set up in the following manner before the measurement and the analysis.

In dedicated software “screen for changing standard measuring method (SOM)”, the total count number in the control mode is set to 50,000 particles, the number of times of measurement is set to once, and a value obtained by using “nominal particle 10.0 μm” (manufactured by Beckman Coulter, Inc.) is set as the Kd value. The threshold value and the noise level are automatically set by pressing the measurement button of the threshold value/noise level. Further, the current is set to 1,600 μA, the gain is set to 2, the electrolyte solution is set to ISOTON II, and the aperture tube flash after measurement is checked.

In dedicated software “setting screen for converting pulse to particle diameter”, the bin interval is set to the logarithmic particle diameter, the particle diameter bin is set to 256 particle diameter bin, and the particle diameter range is set to be in a range of 2 μm to 60 μm.

The specific measuring method is as follows.
1. A 250 mL round-bottom glass beaker for exclusive use of Multisizer 3 is charged with about 200 mL of the electrolyte solution and set on a sample stand, and the solution is stirred with a stirrer rod at 24 rotations/sec in a counterclockwise direction. Further, the stain and air bubbles inside the aperture tube are removed by the function of the analysis software “aperture tube flash”.
2. A 100 ml flat-bottom glass beaker is charged with about 30 mL of the electrolyte solution, and about 0.3 mL of a diluent obtained by diluting “Contaminon N” (10 mass % aqueous solution of neutral detergent for washing precision measuring machine with pH of 7, which is formed of nonionic surfactant, anionic surfactant, and organic builder, manufactured by FUJIFILM Wako Pure Chemical Corporation) to 3 times by mass with ion exchange water is added thereto as a dispersant.
3. A predetermined amount of ion exchange water is poured into a water tank of an ultrasonic disperser “Ultrasonic Dispersion System Tetoral 150” with an electrical output of 120 W, which is provided with two built-in oscillators having an oscillation frequency of 50 kHz in a state of a phase shift of 180 degrees, and about 2 mL of Contaminon N is added to the water tank.
4. The beaker of the item (2) is set in a beaker fixing hole of the ultrasonic disperser, and the ultrasonic disperser is operated. Further, the position of the height of the beaker is adjusted such that the resonance state of the liquid level of the electrolyte solution in the beaker is maximized.
5. The electrolyte solution in the beaker of the item (4) is irradiated with ultrasonic waves, and about 10 mg of the toner is added to the electrolyte solution little by little and dispersed therein. Further, an ultrasonic dispersion treatment is further continued for 60 seconds. In addition, the water temperature in the water tank is appropriately adjusted to 10° C. or higher and 40° C. or lower in the ultrasonic dispersion treatment.
6. The electrolyte solution of the item (5) in which the toner has been dispersed using a pipette is added dropwise to the round-bottom beaker of the item 1. disposed in the sample stand, and the measurement concentration is adjusted to about 5%.

Further, the measurement is performed until the number of measured particles reaches 50,000.
7. The weight-average particle diameter (D4) and the number average particle diameter (D1) are calculated by analyzing the measurement data using the dedicated software attached to a device. Further, “arithmetic diameter” of the analysis/number statistics (arithmetic average) screen and “arithmetic diameter” of the analysis/volume statistics (arithmetic average) screen are respectively the number average particle diameter (D1) and the weight-average particle diameter (D4) in a case where the graph/number % and the graph/vol % are set with the dedicated software.
   Method of Separating Titanate Fine Particles from Surface of Toner

1.6 kg of sucrose (manufactured by Kishida Chemical Co., Ltd.) is added to 1 L of ion exchange water and dissolved in a hot water bath, thereby preparing a concentrated sucrose solution. 31 g of the concentrated sucrose solution and 6 mL of Contaminon N (10 mass % aqueous solution of neutral detergent for washing precision measuring machine with pH of 7, which is formed of nonionic surfactant, anionic surfactant, and organic builder, manufactured by FUJIFILM Wako Pure Chemical Corporation) are poured into a centrifuge tube to prepare a dispersion liquid. 10 g of the toner is added to this dispersion liquid, and the toner clumps are broken up with a spatula or the like.

The centrifuge tube is set in “KM Shaker” (model: V-SX, manufactured by Iwaki Industry Co., Ltd.) and shaken at 350 strokes per minute for 20 minutes. After the shaking, the solution is transferred to a glass tube (50 mL) for a swing rotor and centrifuged in a centrifuge under conditions of 3,500 rpm for 30 minutes.

In the glass tube after the centrifugation, toner particles are present in the uppermost layer, and an inorganic fine particle mixture containing the titanate fine particles is present in the underlayer on the aqueous solution side. The aqueous solution of the underlayer is separated and dried to obtain the inorganic fine particle mixture. The above-described centrifugation step is repeatedly performed such that the total amount of the obtained inorganic fine particle mixture reaches 10 g or greater.

Next, 10 g of the obtained inorganic fine particle mixture is added to and dispersed in a dispersion liquid to which 100 mL of ion exchange water and 6 mL of Contaminon N have been added. The obtained dispersion liquid is transferred to a glass tube (50 mL) for a swing rotor and centrifuged in a centrifuge under conditions of 3,500 rpm for 30 minutes.

In the glass tube after the centrifugation, titanate fine particles are present in the lowermost layer, and other inorganic fine particles are present in the upper layer on the aqueous solution side.

A mixture of the inorganic fine particles including the titanate fine particles in the lowermost layer is collected, the centrifugation operation is repeatedly performed as necessary to sufficiently carry out separation, and the titanate fine particles are separated, dried, and collected. The operation is repeatedly performed until a required amount of the titanate fine particles can be collected.

### Method of Identifying Surface Treatment Agent of Titanate Fine Particles

1 mL of chloroform is added to 0.05 g of the obtained titanate fine particles. The obtained sample solution is treated by an ultrasonic disperser for 10 minutes to extract a surface treatment agent from the chloroform solution.

Further, solid matter is removed by centrifugation (model: HITACHI himac CR22G, condition: 12,000 rpm) and filter filtration. The obtained solution is analyzed by gas chromatography mass spectrometry (GC-MS).

Specifically, the measurement is performed under the conditions described below.
GCMS device: Trace 1310 (manufactured by Thermo Fisher Scientific Inc.), ISQ (manufactured by Thermo Fisher Scientific Inc.)
Column: HP-5 ms (30 m)
Temperature of injection port: 250° C., Injection volume: 1 μL
Temperature of column oven: 40° C.→300° C. (15° C./min)
MS ionization mode: EI, Temperature of ion source: 250° C., Mass range: 35 to 800 m/z

The profile obtained by the analysis is analyzed, and each peak position and the mass spectrum of the measured sample are confirmed to identify the treatment agent present on the surface of the titanate fine particles.

### Composition Analysis of Titanate Fine Particles

The composition of the titanate fine particles is analyzed in the following manner.

The titanate fine particles are observed with an SEM and analyzed with an EDX. An analyzer described below is used. Further, the titanate fine particles are separated and collected from the surface of the toner by the above-described method.
SEM: JSM 7800, manufactured by JEOL Ltd.
EDX: Talos F200X, manufactured by Thermo Fisher Scientific Inc.

The observation is performed at a magnification of 10,000 times, the composition is analyzed with an EDX to confirm that the titanate fine particles are particles formed of at least titanium and oxygen. Further, quantitative analysis is also performed using an X-ray diffraction device (XRD) to confirm that the titanate fine particles are oxides of titanium.

### Method of Measuring Content of Titanate Fine Particles

The content A of the titanate fine particles in units of % by mass is quantified by a standard addition method. Hereinafter, a case where a titanate is strontium titanate will be described in detail as an example.

3 g of the toner is placed in an aluminum ring having a diameter of 30 mm to prepare pellets under a pressure of 10 tons.

Further, the intensity of strontium (Sr) is determined (Sr intensity-1) by wavelength dispersive X-ray fluorescence analysis (XRF). Further, the measurement may be performed under conditions optimized for an XRF device to be used, but a series of measurements are all performed under the same conditions. Strontium titanate particles are mixed into the toner particles such that the content thereof is 1.0% by mass with respect to the amount of the toner particles, and the mixture is mixed in a coffee mill. After the mixing, the mixture is pelletized in the same manner as described above, and the Sr intensity is determined in the same manner as described above (Sr intensity-2). The same operation as described above is performed to determine the Sr intensities (Sr intensity-3 and Sr intensity-4) even for samples obtained by adding 2.0% by mass and 3.0% by mass of strontium titanate particles to the toner particles. The content (% by mass) of strontium titanate in the toner is calculated by a standard addition method using the Sr intensity-1 to the Sr intensity-4.

The content in other titanates can also be quantified by the same method as described above.

### Method of Measuring Dielectric Constant of Titanate Fine Particles

The relative dielectric constant of the titanate fine particles is measured by using a power supply, SI 1260 Electrochemical Interface (manufactured by TOYO Corporation) as an ammeter, and 1296 Dielectric Interface (manufactured by TOYO Corporation) as a current amplifier. A sample subjected to heat molding into a disc shape with a thickness of 3.0±0.5 mm using a tablet molder is used as the measurement sample. Gold electrodes are prepared on the upper and lower surfaces of the sample in a circular shape with a diameter of 10 mm using mask deposition. Measurement electrodes are attached to the prepared measurement sample, and an Ac voltage with a peak-to-peak voltage (Vp-p) of 100 mV is applied at a frequency of 0.1 MHz to measure the capacitance and the impedance.

A relative dielectric constant er and a volume resistivity ρv of the measurement sample are calculated from the following equations.

$$ε r = dC / ε0 S \\ ρ v = ZS / d$$

d: thickness (m) of measurement sample
C: capacitance (F)
ε0: dielectric constant of vacuum (F/m)
S: electrode area (m²)
Z: impedance (Ω)

### Method of Calculating Number Average Particle Diameter of Primary Particles of Titanate Fine Particles

The number average particle diameter of the primary particles of the titanate fine particles is calculated by using an image obtained by observing a backscattered electron image with S-4800. Since a backscattered electron image causes less charge-up of the titanate fine particles as compared with a secondary electron image, the particle diameter can be measured with high accuracy.

Liquid nitrogen is poured into the anti-contamination trap attached to the housing of S-4800 until the liquid nitrogen overflows, and allowed to stand for 30 minutes. Next, “PC-SEM” of S-4800 is started to perform flashing (cleaning of the FE chip serving as an electron source). The flashing execution dialog is opened by clicking the acceleration voltage display area of the control panel on the screen and pressing the [flashing] button. The flashing is executed after confirming that the flashing intensity is 2. The emission current due to the flashing is confirmed to be in a range of 20 to 40 μA. The sample holder is inserted into the sample chamber of the housing of S-4800. The sample holder is moved to the observation position by pressing [Home] on the control panel.

The acceleration voltage display area is clicked to open the HV setting dialog, the acceleration voltage is set to [0.8 kV], and the emission current is set to [20 μA]. In the [Base] tab of the operation panel, the signal selection is set to [SE], [Up (U)] and [+BSE] are selected for the SE detector, [L.A. 100] in the selection box on the right side of [+BSE] is selected to set a backscattered electron image observation mode. Similarly, in the [Base] tab of the operation panel, the probe current of the electron optical system condition block is set to [Normal], the focus mode is set to [UHR], and WD is set to [3.0 mm]. The [ON] button of the acceleration voltage display area of the control panel is pressed to apply the acceleration voltage.

### (3) Focus Adjustment

The inside of the magnification display area of the control panel is dragged to set the magnification to 100,000 (100 k) times. The focus knob [COARSE] of the operation panel is allowed to rotate to adjust the aperture alignment when a certain degree of focus is obtained. Next, [Align] of the control panel is clicked to display the alignment dialog, and [Beam] is selected. The beam to be displayed is moved to the center of the concentric circle by rotating the STIGMA/ALIGNMENT knobs (X, Y) of the operation panel. Next, [Aperture] is selected and the STIGMA/ALIGNMENT knobs (X, Y) are allowed to rotate one by one to stop the movement of the image or to minimize the movement of the image. The aperture dialog is closed, and the focus is adjusted by autofocus.

The focus is adjusted by repeating the operation two more times.

### (4) Image Storage

The brightness is adjusted in an ABC mode, a photograph is taken with a size of 640×480 pixels and stored. The following analysis is performed by using this image file. One photograph is taken for one titanate fine particle, and images are obtained for at least 300 or more particles.

### (3) Calculation of Number Average Particle Diameter of Primary Particles of Titanate Fine Particles

The number average particle diameter of the primary particles is obtained by determining the maximum diameters of 300 titanate fine particles and arithmetically averaging the obtained maximum diameters thereof.

Further, it is possible to determine whether or not the particles are titanate fine particles by combining element analysis using energy dispersive X-ray spectroscopy (EDS). Specifically, the toner is observed in a visual field magnified up to 100,000 times using a scanning electron microscope “S-4800” (trade name, manufactured by Hitachi Ltd.). The external additive to be determined is observed by focusing on the surface of the toner particles. EDS analysis is performed on the external additive to be determined to find whether or not the particles are titanate fine particles from the elemental peaks. Method of quantifying aluminum element in toner particles

The fluorescent X-rays of each element are measured in conformity with JIS K 0119-1969, and the specific method thereof is as follows.

A wavelength dispersive X-ray fluorescence analyzer “Axios” (manufactured by PANalytical) is used as a measuring device, and dedicated software “SuperQ ver. 4.0F” (manufactured by PANalytical) attached to the device, which is used for setting the measurement conditions and analyzing the measurement data is used. Further, Rh is used as an anode of the X-ray tube, the measurement is performed in a vacuum atmosphere, the measurement diameter (collimator mask diameter) is set to 27 mm, and the measurement time is set to 10 seconds. Further, light elements are measured by performing detection with a proportional counter (PC), and heavy elements are measured by performing detection with a scintillation counter (SC).

A pellet having a thickness of about 2 mm and a diameter of about 39 mm, molded by putting about 4 g of the toner particles into a dedicated aluminum ring for pressing, flattening the surface thereof, and pressurizing the surface at 20 MPa for 60 seconds using a tablet compression molding machine “BRE-32” (manufactured by Maekawa Testing Machine MFG Co., Ltd.), is used as a measurement sample.

The measurement is performed by setting the acceleration voltage of an X-ray generating device to 24 kV and the current value to 160 mA, the elements are identified based on the obtained peak positions of X-rays, and the concentration thereof is calculated from the counting rate (unit: cps), which is the number of X-ray photons per unit time.

### EXAMPLES

Hereinafter, the present disclosure will be described in more detail with reference to examples and comparative examples, but the present disclosure is not limited thereto. Unless otherwise specified, “parts” used in the examples are on a mass basis.

### Production Example 1 of Polyester A

Bisphenol A-ethylene oxide 2-mole adduct: 27 parts by mole
Bisphenol A-propylene oxide 2-mole adduct: 73 parts by mole
Isophthalic acid: 100 parts by mole

A flask provided with a stirring device, a nitrogen introduction pipe, a temperature sensor, and a rectifying tower was charged with the above-described monomers and heated to 190° C. for 1 hour, and it was confirmed that the mixture in the reaction system was uniformly stirred. 0.9 parts of tin distearate was added thereto with respect to 100 parts of these monomers. The temperature was increased from 190° C. to 250° C. over 5 hours while water which was further generated was distilled off, and a dehydration condensation reaction was further carried out at 250° C. for 2 hours.

As a result, polyester A-1 having a glass transition temperature of 60.0° C., an acid value of 10 mgKOH/g, a hydroxyl value of 26 mgKOH/g, an Mn of 4,800, and a ratio Mw/Mn of 6.0 was obtained.

### Production Examples 2 to 13 of Polyester A

Each of polyesters A-2 to A-13 was obtained in the same manner as in Production Example 1 of the polyester A except that the monomer used was changed as listed in Table 1 and the reaction temperature and the time for the dehydration condensation reaction were changed such that the Mn and the ratio Mw/Mn of the obtained polyester A reached desired values. The results are listed in Table 1.

Further, each of polyester A-4 and polyester A-5 was produced by using, as an alcohol component, ethylene glycol in the amount listed in Table 1 in addition to the bisphenol A-ethylene oxide 2-mole adduct (BPA-EO) and the bisphenol A-propylene oxide 2-mole adduct (BPA-PO) as the raw materials.

TABLE 1

| Polyester A | A-1 | A-2 | A-3 | A-4 | A-5 | A-6 | A-7 | A-8 | A-9 | A-10 | A-11 | A-12 | A-13 |
|---|---|---|---|---|---|---|---|---|---|---|---|---|---|
| Isophthalic acid | 100 | 100 | 100 | 100 | 100 | 90 | 90 | 90 | 90 | 80 | 100 | 100 | 0 |
| (number of moles) | | | | | | | | | | | | | |
| Terephthalic acid | 0 | 0 | 0 | 0 | 0 | 10 | 10 | 10 | 10 | 20 | 0 | 0 | 100 |
| (number of moles) | | | | | | | | | | | | | |
| BPA-EO | 27 | 27 | 27 | 27 | 27 | 15 | 40 | 5 | 50 | 27 | 27 | 27 | 27 |
| (number of moles) | | | | | | | | | | | | | |
| BPA-PO | 73 | 73 | 73 | 63 | 58 | 85 | 60 | 95 | 50 | 73 | 73 | 73 | 73 |
| (number of moles) | | | | | | | | | | | | | |
| Ethylene glycol | 0 | 0 | 0 | 10 | 15 | 0 | 0 | 0 | 0 | 0 | 0 | 0 | 0 |
| (number of moles) | | | | | | | | | | | | | |
| Mn | 4800 | 8000 | 10000 | 8000 | 3600 | 3500 | 3500 | 3000 | 3000 | 4700 | 10600 | 2800 | 8900 |
| Mw/Mn | 6.0 | 5.9 | 5.1 | 6.2 | 5.6 | 3.2 | 3.2 | 2.5 | 2.5 | 5.9 | 5.4 | 2.3 | 3.1 |
| Proportion of Uᵢₛₒ in | 100 | 100 | 100 | 100 | 100 | 90 | 90 | 90 | 90 | 80 | 100 | 100 | 0 |
| all acids | | | | | | | | | | | | | |
| (% by mole) | | | | | | | | | | | | | |
| Proportion of U_{EO} + | 100 | 100 | 100 | 90 | 85 | 100 | 100 | 100 | 100 | 100 | 100 | 100 | 100 |
| U_{PO} in all alcohols | | | | | | | | | | | | | |
| (% by mole) | | | | | | | | | | | | | |
| Proportion of U_{EO} in | 27 | 27 | 27 | 30 | 31.8 | 15 | 40 | 5 | 50 | 27 | 27 | 27 | 27 |
| U_{PO} + U_{EO} | | | | | | | | | | | | | |
| (% by mole) | | | | | | | | | | | | | |

### Production Example 1 of Crystalline Polyester

1,10-Decanedicarboxylic acid: 100 parts by mole
1,9-Nonanediol: 100 parts by mole
Tin dioctylate as a catalyst: 0.8 parts with respect to total weight of acid alcohol

A heated and dried two-neck flask of a reaction tank equipped with a nitrogen introduction tube, a dehydration tube, a stirrer, and a thermocouple was charged with the above-described materials, nitrogen gas was introduced into the container, and the mixture was maintained in an inert atmosphere and heated while being stirred. Thereafter, the mixture was stirred at 170° C. for 6 hours. Next, the mixture was gradually heated to 230° C. under reduced pressure while being continuously stirred, and further maintained for 3 hours. The mixture was air-cooled when entered in a viscous state, and the reaction was stopped, thereby producing crystalline polyester 1. The obtained physical properties are listed in Table 2.

### Production Examples 2 and 3 of Crystalline Polyester

Each of crystalline polyester 2 and 3 was obtained in the same manner as described above except that the alcohol monomer and the acid monomer used were changed as listed in Table 2 in Production Example 1 of crystalline polyester. The physical properties of the crystalline polyesters 2 and 3 are listed in Table 2.

TABLE 2

| | Crystalline | Crystalline | Crystalline |
|---|---|---|---|
| | polyester 1 | polyester 2 | polyester 3 |
| Alcohol | 1,9-Nonanediol | 1,12- | 1,12- |
| monomer | | Dodecanediol | Dodecanediol |
| Acid monomer | 1,10-Decanedi- | Sebacic acid | Adipic acid |
| | carboxylic acid | | |
| Acid value | 2 | 3 | 4 |
| (mgKOH/g) | | | |
| Melting point | 70 | 80 | 74 |
| (° C.) | | | |
| Mn | 11000 | 10000 | 14000 |
| Mw/Mn | 2.1 | 2.1 | 2.3 |

### Production Example of Titanate Fine Particles 1

A hydrous titanium oxide slurry obtained by hydrolyzing a titanyl sulfate aqueous solution was washed with an alkali aqueous solution. Next, hydrochloric acid was added to the hydrous titanate oxide slurry to adjust the pH to 0.65, thereby obtaining a titania sol dispersion liquid. NaOH was added to the titania sol dispersion liquid to adjust the pH of the dispersion liquid to 4.5, and the dispersion liquid was repeatedly washed until the electric conductivity of the supernatant reached 70 μS/cm.

Sr(OH)₂·8H₂O was added to the hydrous titanium oxide in an amount of 0.97 times the molar amount of the hydrous titanium oxide, placed in a SUS reaction container, and replaced with nitrogen gas. Further, distilled water was added thereto such that the concentration thereof reached 0.5 mol/L in terms of SrTiO₃. The slurry was heated to 83° C. at a rate of 6.5° C./h in a nitrogen atmosphere, and allowed to react for 6 hours after the temperature thereof reached 83° C. The slurry was cooled to room temperature after the reaction, the supernatant was removed, and the resultant was repeatedly washed with pure water.

The temperature of the obtained slurry containing the precipitation was adjusted to 40° C., hydrochloric acid was added thereto to adjust the pH to 2.5, 1.2 parts of stearic acid was added thereto with respect to 100 parts of the solid content, and the mixture was continuously stirred for 10 hours. A 5 mol/L sodium hydroxide solution was added thereto to adjust the pH to 6.5, and the solution was continuously stirred for 1 hour. Thereafter, the solution was filtered, washed, and dried in the atmosphere at 120° C. for 8 hours, thereby obtaining titanate fine particles 1. The number average particle diameter of the primary particles of the obtained titanate fine particles 1 was 100 nm.

### Production Example of Titanate Fine Particles 2

A hydrous titanium oxide slurry obtained by hydrolyzing a titanyl sulfate aqueous solution was washed with an alkali aqueous solution. Next, hydrochloric acid was added to the hydrous titanate oxide slurry to adjust the pH to 0.5, thereby obtaining a titania sol dispersion liquid. NaOH was added to the titania sol dispersion liquid to adjust the pH of the dispersion liquid to 4.0, and the dispersion liquid was repeatedly washed until the electric conductivity of the supernatant reached 70 μS/cm.

Sr(OH)₂·8H₂O was added to the hydrous titanium oxide in an amount of 0.93 times the molar amount of the hydrous titanium oxide, placed in a SUS reaction container, and replaced with nitrogen gas. Further, distilled water was added thereto such that the concentration thereof reached 0.7 mol/L in terms of SrTiO₃.

The slurry was heated to 70° C. at a rate of 8.5° C./h in a nitrogen atmosphere, and allowed to react for 5 hours after the temperature thereof reached 70° C. The slurry was cooled to room temperature after the reaction, the supernatant was removed, and the resultant was repeatedly washed with pure water.

The temperature of the obtained slurry containing the precipitation was adjusted to 40° C., hydrochloric acid was added thereto to adjust the pH to 2.5, 1.2 parts of stearic acid was added thereto with respect to 100 parts of the solid content, and the mixture was continuously stirred for 10 hours. A 5 mol/L sodium hydroxide solution was added thereto to adjust the pH to 6.5, and the solution was continuously stirred for 1 hour. Thereafter, the solution was filtered, washed, and dried in the atmosphere at 120° C. for 8 hours, thereby obtaining titanate fine particles 2. The number average particle diameter of the primary particles of the obtained titanate fine particles 2 was 30 nm.

### Production Example of Titanate Fine Particles 3

600 g of strontium carbonate and 320 g of titanium oxide were wet-mixed in a ball mill for 8 hours, and the mixture was filtered and dried. The mixture was molded under a pressure of 0.49 MPa (5 kg/cm²), calcined at 1,100° C. for 8 hours, and mechanically pulverized, thereby obtaining strontium titanate particles. 100 parts of pure water was added to 100 parts of obtained particles, and the mixture was stirred to form a slurry. Hydrochloric acid was added to the slurry to adjust the pH to 2.5, the temperature thereof was adjusted to 40° C., 1.2 parts of stearic acid was added thereto with respect to 100 parts of the solid content, and the mixture was continuously stirred for 10 hours. A 5 mol/L sodium hydroxide solution was added thereto to adjust the pH to 6.5, and the solution was continuously stirred for 1 hour. Thereafter, the solution was filtered, washed, and dried in the atmosphere at 120° C. for 8 hours, thereby obtaining titanate fine particles 3. The number average particle diameter of the primary particles of the obtained titanate fine particles 3 was 300 nm.

### Production Example of Titanate Fine Particles 4

Titanate fine particles 4 were obtained by the same production method as that for the titanate fine particles 1 except that lauric acid was used in place of the stearic acid used in the production example of the titanate fine particles 1.

The number average particle diameter of the primary particles of the obtained titanate fine particles 4 was 100 nm.

### Production Example of Titanate Fine Particles 5

Titanate fine particles 5 were obtained by the same production method as that for the titanate fine particles 1 except that montanoic acid was used in place of the stearic acid used in the production example of the titanate fine particles 1.

The number average particle diameter of the primary particles of the obtained titanate fine particles 5 was 100 nm.

### Production Example of Titanate Fine Particles 6

Titanate fine particles 6 were obtained by the same production method as that for the titanate fine particles 1 except that the treatment performed using stearic acid in the production example of the titanate fine particles 1 was not performed. The number average particle diameter of the primary particles of the obtained titanate fine particles 6 was 100 nm.

### Production Example of Titanate Fine Particles 7

Metatitanic acid obtained by a sulfuric acid method was subjected to a deironization bleaching treatment, a sodium hydroxide aqueous solution was added thereto to adjusts the pH to 9.0, and the solution was subjected to a desulfurization treatment, neutralized with hydrochloric acid until the pH thereof reached 5.8, filtered, and washed with water. Water was added to the washed cake to obtain a TiO₂ slurry at a concentration of 1.85 mol/L, hydrochloric acid was added thereto to adjust the pH to 1.0, and the resultant was subjected to a peptization treatment.

1.88 moles of the metatitanic acid that had been subjected to desulfurization and peptization was collected as TiO₂ and put into a 3 L reaction container. 2.16 moles of a calcium chloride aqueous solution was added to the peptized metatitanic acid slurry such that the molar ratio Ca/Ti reached 1.15, and the TiO₂ concentration was adjusted to 0.5 mol/L. Next, the solution was heated to 90° C. while being stirred and mixed, 440 mL of a 10 mol/L sodium hydroxide aqueous solution was added thereto over 45 hours, the resulting solution was continuously stirred at 95° C. for 1 hour, and the reaction was completed.

The reaction slurry was cooled to 50° C., hydrochloric acid was added thereto until the pH thereof reached 5.0, and the mixture was continuously stirred for 20 minutes. The obtained precipitate was washed by decantation, filtered, separated, and dried in the atmosphere at 120° C. for 8 hours. Next, 300 g of a dried product was put into a dry particle composite device (NOBILTA NOB-130, manufactured by Hosokawa Micron Corporation). The dried product was subjected to a treatment at a treatment temperature of 30° C. using a rotary treatment blade at a speed of 90 m/sec for 10 minutes.

Hydrochloric acid was further added to the dried product until the pH thereof reached 0.1, and the mixture was continuously stirred for 1 hour. The obtained precipitate was washed by decantation. The temperature of the obtained slurry containing the precipitate was adjusted to 40° C., hydrochloric acid was added thereto to adjust the pH thereof to 2.5, 1.2 parts of stearic acid was added to 100 parts of the solid content, and the mixture was continuously stirred for 10 hours. A 5 mol/L sodium hydroxide solution was added thereto to adjust the pH thereof to 6.5, and the solution was continuously stirred for 1 hour. Thereafter, the solution was filtered, washed, and dried in the atmosphere at 120° C. for 8 hours, thereby obtaining titanate fine particles 7. The number average particle diameter of the primary particles of the obtained titanate fine particles 7 was 100 nm.

### Production Example of Titanate Fine Particles 8

Titanate fine particles 8 were obtained by the same production method as that for the titanate fine particles 7 except that barium chloride was used in place of the calcium chloride used in the production example of the titanate fine particles 7. The number average particle diameter of the primary particles of the obtained titanate fine particles 8 was 100 nm.

### Production Example of Titanate Fine Particles 9

Titanate fine particles 9 were obtained by the same production method as that for the titanate fine particles 7 except that potassium chloride was used in place of the calcium chloride used in the production example of the titanate fine particles 7. The number average particle diameter of the primary particles of the obtained titanate fine particles 9 was 100 nm.

### Production Example of Titanate Fine Particles 10

Titanate fine particles 10 were obtained by the same production method as that for the titanate fine particles 1 except that n-octylethoxysilane was used in place of the stearic acid used in the production example of the titanate fine particles 1. The number average particle diameter of the primary particles of the obtained titanate fine particles 10 was 100 nm.

### Production Example of Titanate Fine Particles 11

A hydrous titanium oxide slurry obtained by hydrolyzing a titanyl sulfate aqueous solution was washed with an alkali aqueous solution. Next, hydrochloric acid was added to the hydrous titanate oxide slurry to adjust the pH thereof to 0.65, thereby obtaining a titania sol dispersion liquid. NaOH was added to the titania sol dispersion liquid to adjust the pH of the dispersion liquid to 4.5, and the dispersion liquid was repeatedly washed until the electric conductivity of the supernatant reached 70 μS/cm.

Sr(OH)₂·8H₂O was added to the hydrous titanium oxide in an amount of 0.97 times the molar amount of the hydrous titanium oxide, placed in a SUS reaction container, and replaced with nitrogen gas. Further, distilled water was added thereto such that the concentration thereof reached 0.5 mol/L in terms of SrTiO₃. The slurry was heated to 83° C. at a rate of 6.5° C./h in a nitrogen atmosphere, and allowed to react for 6 hours after the temperature thereof reached 83° C. The slurry was cooled to room temperature after the reaction, the supernatant was removed, and the resultant was repeatedly washed with pure water.

The strontium titanate particles were subjected to a wet hydrophobic treatment by adding 0.7 parts of a silicone oil emulsion (dimethylpolysiloxane-based emulsion) “SM7036EX” (manufactured by Dow Corning Toray Silicone Co., Ltd) with respect to 100 parts of the solid content of the obtained slurry containing the precipitate and stirring the mixture for 30 minutes. Next, a 4.0 mol/L sodium hydroxide aqueous solution was added thereto to adjust the pH thereof to 6.5, and the solution was filtered, washed, and dried at 120° C. for 8 hours, thereby obtaining titanate fine particles 11. The number average particle diameter of the primary particles of the obtained titanate fine particles 11 was 100 nm.

The results obtained by measuring the dielectric constants of the obtained titanate fine particles 1 to 11 by the method described in <Method of measuring dielectric constant of titanate fine particles> above are listed in Table 3.

TABLE 3

| | | Number | | |
|---|---|---|---|---|
| | | average | | |
| | | particle | | Relative |
| | Type of | diameter | Surface | dielectric |
| | titanate | (nm) | treatment | constant |
| Titanate fine | Strontium | 100 | Stearic acid | 250 |
| particles 1 | titanate | | | |
| Titanate fine | Strontium | 30 | Stearic acid | 250 |
| particles 2 | titanate | | | |
| Titanate fine | Strontium | 300 | Stearic acid | 250 |
| particles 3 | titanate | | | |
| Titanate fine | Strontium | 100 | Lauric acid | 250 |
| particles 4 | titanate | | | |
| Titanate fine | Strontium | 100 | Montanoic acid | 250 |
| particles 5 | titanate | | | |
| Titanate fine | Strontium | 100 | None | 250 |
| particles 6 | titanate | | | |
| Titanate fine | Calcium | 100 | Stearic acid | 150 |
| particles 7 | titanate | | | |
| Titanate fine | Barium | 100 | Stearic acid | 2000 |
| particles 8 | titanate | | | |
| Titanate fine | Potassium | 100 | Stearic acid | 5 |
| particles 9 | titanate | | | |
| Titanate fine | Strontium | 100 | Octylsilane | 250 |
| particles 10 | titanate | | | |
| Titanate fine | Strontium | 100 | Silicone oil | 250 |
| particles 11 | titanate | | | |

### Preparation of Resin Particle Dispersion Liquid of Polyester A-1

Polyester A-1: 100 parts
Methyl ethyl ketone: 50 parts
Isopropyl alcohol: 20 parts

The methyl ethyl ketone and the isopropyl alcohol were added to a container. Thereafter, the polyester A-1 was gradually added thereto, the mixture was stirred for complete dissolution, thereby obtaining a polyester A-1-dissolved liquid. The temperature of the container containing the polyester A-1-dissolved liquid was set to 65° C., a 10% ammonia aqueous solution was gradually added dropwise to the container so that the total amount of the solution reached 5 parts while the solution was stirred, and 230 parts of ion exchange water was further gradually added dropwise thereto at a rate of 10 mL/min to cause phase inversion emulsification. Further, desolvation was performed under reduced pressure using an evaporator, thereby obtaining a resin particle dispersion liquid of the polyester A-1. The volume average particle diameter of the resin particles contained in the resin particle dissolved-liquid was 130 nm. Further, the solid content was adjusted to 20% with ion exchange water.

### Preparation of Resin Particle Dispersion Liquid of Crystalline Polyester 1

Crystalline polyester 1:100 parts
Methyl ethyl ketone: 50 parts
Isopropyl alcohol: 20 parts

The methyl ethyl ketone and the isopropyl alcohol were added to a container. Thereafter, the crystalline polyester 1 was gradually added thereto, the mixture was stirred for complete dissolution, thereby obtaining a crystalline polyester 1-dissolved liquid. The temperature of the container containing the crystalline polyester 1-dissolved liquid was set to 40° C., a 10% ammonia aqueous solution was gradually added dropwise to the container so that the total amount of the solution reached 3.5 parts while the solution was stirred, and 230 parts of ion exchange water was further gradually added dropwise thereto at a rate of 10 mL/min to cause phase inversion emulsification. Further, desolvation was performed under reduced pressure, thereby obtaining a resin particle dispersion liquid of the crystalline polyester 1. The volume average particle diameter of the resin particles contained in the resin particle dissolved-liquid was 150 nm. Further, the solid content was adjusted to 20% with ion exchange water.

### Preparation of Colorant Particle Dispersion Liquid

Copper phthalocyanine (Pigment Blue 15:3): 45 parts
Ionic surfactant NEOGEN RK (manufactured by DKS Co., Ltd.): 5 parts
Ion exchange water: 190 parts

The above-described components were mixed and dispersed for 10 minutes using a homogenizer (ULTRA-TURRAX, manufactured by IKA). Next, the mixture was subjected to a dispersion treatment at a pressure of 250 MPa for 20 minutes using an ULTIMIZER (opposition collision type wet pulverizer, manufactured by Sugino Machine Ltd.), thereby obtaining a colorant particle dispersion liquid in which the volume average particle diameter of the colorant particles was 120 nm and the solid content thereof was 20%.

### Preparation of Release Agent Particle Dispersion Liquid

Release agent (hydrocarbon wax, melting point: 79° C.): 15 parts
Ionic surfactant NEOGEN RK (manufactured by DKS Co., Ltd.): 2 parts
Ion exchange water: 240 parts

The above-described components were heated to 100° C. and sufficiently dispersed with an ULTRA-TURRAX T50 (manufactured by IKA). Next, the mixture was heated to 115° C. with a pressure discharge type Gaulin homogenizer and subjected to a dispersion treatment for 1 hour, thereby obtaining a release agent particle dispersion liquid having a volume average particle diameter of 160 nm and a solid content of 20%.

### Production Example of Toner Particles 1

Resin particle dispersion liquid of polyester A-1:900 parts
Resin particle dispersion liquid of crystalline polyester 1:100 parts
Colorant particle dispersion liquid: 50 parts
Release agent particle dispersion liquid: 80 parts

First, the above-described materials were added to a round stainless steel flask and mixed. Next, the mixture was dispersed using a homogenizer ULTRA-TURRAX T50 (manufactured by IKA) at 5,000 r/min for 10 minutes. A 1 mol/L sodium hydroxide aqueous solution was added thereto to adjust the pH to 8.0, and an aqueous solution obtained by dissolving 0.50 parts of aluminum chloride as an aggregating agent in 20 parts of ion exchange water was added thereto over 10 minutes while the solution was stirred at 30° C. The solution was allowed to stand for 3 minutes and heated to 50° C. to generate aggregated particles.

The volume average particle diameter of the formed aggregated particles was appropriately confirmed by using COULTER Multisizer III, and in a case where aggregated particles having a diameter of 6.0 μm were formed, the aggregation step was finished.

Thereafter, a 1 mol/L sodium hydroxide aqueous solution was added thereto to adjust the pH to 9.0, continuously stirred, and heated to 92° C. in the spheronization step.

The heating of the mixture was stopped when a desired surface shape was obtained, the mixture was cooled to 40° C. by quickly adding ice thereto in the cooling step such that the cooling rate was set to 10° C./sec or greater, and an annealing treatment was performed at 55° C. for 3 hours in the annealing step.

Thereafter, the mixture was cooled to 25° C., filtered, solid-liquid separated, and washed with ion exchange water. After completion of the washing, the mixture was dried using a vacuum dryer, thereby obtaining toner particles 1 having a weight-average particle diameter (D4) of 7.1 μm. The formulation and the physical properties of the toner particles 1 are listed in Table 4.

### Production Examples of Toner Particles 2 to 23 and 25 to 44

Toner particles 2 to 23 and 25 to 44 were obtained by the same method as in the production example of the toner particles 1 except that the combination of materials used and the production conditions were changed such that the formulations and the physical properties listed in Table 4 were obtained.

### Production Example of Toner Particles 24

### Production of Toner Particles by Pulverization Method

The following materials were sufficiently mixed with an FM mixer (manufactured by NIPPON COKE & ENGINEERING CO., LTD.) and melt-kneaded with a twin-screw kneader (manufactured by Ikegai Corp.) set at a temperature of 100° C.
Polyester A-1:90.0 parts
Crystalline polyester 1:10.0 parts
Hydrocarbon wax (melting point: 79° C.): 8.0 parts
C.I. Pigment Blue 15:3: 5.0 parts

The obtained kneaded material was cooled and coarsely pulverized to a size of 1 mm or less using a hammer mill, thereby obtaining a coarsely pulverized material.

Next, a finely pulverized material having a size of about 6.5 μm was obtained using a turbo mill (manufactured by FREUNDO-TURBO CORPORATION) from the obtained coarsely pulverized material, and fine and coarse powder was cut out with a multi-division classifier using the Coanda effect, thereby obtaining toner particles 24.

The toner particles 24 had a weight-average particle diameter (D4) of 7.1 μm, a Tg of 58.4° C., and an average circularity of 0.945. The formulation and the physical properties of the toner particles 24 are listed in Table 4.

### Production Example of Toner 1

External addition was performed on the toner particles 1. The external addition was performed by adding 6.0 g (0.3 parts with respect to 100 parts of the toner particles) of the titanate fine particles 1 and 20 g (1.0 parts with respect to 100 parts of the toner particles) of hydrophobic silica fine particles (number average particle diameter of primary particles: 7 nm) which had been surface-treated with dimethyl silicone oil to 2.0 kg of the toner particles 1 and mixing the mixture with an FM mixer (FM10, manufactured by NIPPON COKE & ENGINEERING CO., LTD.) at 3,000 rpm for 5 minutes. Here, the temperature inside the tank after the mixture was mixed for 5 minutes was adjusted to 35° C. by controlling the temperature and the reuse of cold water flowing in a cooling jacket. The physical properties of the obtained toner 1 are listed in Table 4.

### Production Examples of Toner Particles 2 to 44

Toners 2 to 44 were obtained in the same manner as in the production example of the toner 1 except that the kind of the toner particles, and the kind and the content of the titanate fine particles in the production example of the toner 1 were changed as listed in Table 4. The physical properties of the obtained toners 2 to 44 are listed in Table 4.

TABLE 4

| | Toner | Binder resin | | | | | | | | |
|---|---|---|---|---|---|---|---|---|---|---|
| | particles | Polyester A | | [symbol] | | [symbol] | | | | |
| Toner | No. | No. | [symbol] | No. | [symbol] | No. | [symbol] | [symbol] | [symbol] | [symbol] |
| 1 | 1 | [symbol] | [symbol] | [symbol] | [symbol] | [symbol] | [symbol] | [symbol] | [symbol] | [symbol] |
| 2 | 2 | [symbol] | [symbol] | [symbol] | [symbol] | [symbol] | [symbol] | [symbol] | [symbol] | [symbol] |
| 3 | 3 | [symbol] | [symbol] | [symbol] | [symbol] | [symbol] | [symbol] | [symbol] | [symbol] | [symbol] |
| 4 | 4 | [symbol] | [symbol] | [symbol] | [symbol] | [symbol] | [symbol] | [symbol] | [symbol] | [symbol] |
| 5 | 5 | [symbol] | [symbol] | [symbol] | [symbol] | [symbol] | [symbol] | [symbol] | [symbol] | [symbol] |
| 6 | 6 | [symbol] | [symbol] | [symbol] | [symbol] | [symbol] | [symbol] | [symbol] | [symbol] | [symbol] |
| 7 | 7 | [symbol] | [symbol] | [symbol] | [symbol] | [symbol] | [symbol] | [symbol] | [symbol] | [symbol] |
| 8 | 8 | [symbol] | [symbol] | [symbol] | [symbol] | [symbol] | [symbol] | [symbol] | [symbol] | [symbol] |
| 9 | 9 | [symbol] | [symbol] | [symbol] | [symbol] | [symbol] | [symbol] | [symbol] | [symbol] | [symbol] |
| 10 | 10 | [symbol] | [symbol] | [symbol] | [symbol] | [symbol] | [symbol] | [symbol] | [symbol] | [symbol] |
| 11 | 11 | [symbol] | [symbol] | [symbol] | [symbol] | [symbol] | [symbol] | [symbol] | [symbol] | [symbol] |
| 12 | 12 | [symbol] | [symbol] | [symbol] | [symbol] | [symbol] | [symbol] | [symbol] | [symbol] | [symbol] |
| 13 | 13 | [symbol] | [symbol] | [symbol] | [symbol] | [symbol] | [symbol] | [symbol] | [symbol] | [symbol] |
| 14 | 14 | [symbol] | [symbol] | [symbol] | [symbol] | [symbol] | [symbol] | [symbol] | [symbol] | [symbol] |
| 15 | 15 | [symbol] | [symbol] | [symbol] | [symbol] | [symbol] | [symbol] | [symbol] | [symbol] | [symbol] |
| 16 | 16 | [symbol] | [symbol] | [symbol] | [symbol] | [symbol] | [symbol] | [symbol] | [symbol] | [symbol] |
| 17 | 17 | [symbol] | [symbol] | [symbol] | [symbol] | [symbol] | [symbol] | [symbol] | [symbol] | [symbol] |
| 18 | 18 | [symbol] | [symbol] | [symbol] | [symbol] | [symbol] | [symbol] | [symbol] | [symbol] | [symbol] |
| 19 | 19 | [symbol] | [symbol] | [symbol] | [symbol] | [symbol] | [symbol] | [symbol] | [symbol] | [symbol] |
| 20 | 20 | [symbol] | [symbol] | [symbol] | [symbol] | [symbol] | [symbol] | [symbol] | [symbol] | [symbol] |
| 21 | 21 | [symbol] | [symbol] | [symbol] | [symbol] | [symbol] | [symbol] | [symbol] | [symbol] | [symbol] |
| 22 | 22 | [symbol] | [symbol] | [symbol] | [symbol] | [symbol] | [symbol] | [symbol] | [symbol] | [symbol] |
| 23 | 23 | [symbol] | [symbol] | [symbol] | [symbol] | [symbol] | [symbol] | [symbol] | [symbol] | [symbol] |
| 24 | 24 | [symbol] | [symbol] | [symbol] | [symbol] | [symbol] | [symbol] | [symbol] | [symbol] | [symbol] |
| 25 | 25 | [symbol] | [symbol] | [symbol] | [symbol] | [symbol] | [symbol] | [symbol] | [symbol] | [symbol] |
| 26 | 26 | [symbol] | [symbol] | [symbol] | [symbol] | [symbol] | [symbol] | [symbol] | [symbol] | [symbol] |
| 27 | 27 | [symbol] | [symbol] | [symbol] | [symbol] | [symbol] | [symbol] | [symbol] | [symbol] | [symbol] |
| 28 | 28 | [symbol] | [symbol] | [symbol] | [symbol] | [symbol] | [symbol] | [symbol] | [symbol] | [symbol] |
| 29 | 29 | [symbol] | [symbol] | [symbol] | [symbol] | [symbol] | [symbol] | [symbol] | [symbol] | [symbol] |
| 30 | 30 | [symbol] | [symbol] | [symbol] | [symbol] | [symbol] | [symbol] | [symbol] | [symbol] | [symbol] |
| 31 | 31 | [symbol] | [symbol] | [symbol] | [symbol] | [symbol] | [symbol] | [symbol] | [symbol] | [symbol] |
| 32 | 32 | [symbol] | [symbol] | [symbol] | [symbol] | [symbol] | [symbol] | [symbol] | [symbol] | [symbol] |
| 33 | 33 | [symbol] | [symbol] | [symbol] | [symbol] | [symbol] | [symbol] | [symbol] | [symbol] | [symbol] |
| 34 | 34 | [symbol] | [symbol] | [symbol] | [symbol] | [symbol] | [symbol] | [symbol] | [symbol] | [symbol] |
| 35 | 35 | [symbol] | [symbol] | [symbol] | [symbol] | [symbol] | [symbol] | [symbol] | [symbol] | [symbol] |
| 36 | 36 | [symbol] | [symbol] | [symbol] | [symbol] | [symbol] | [symbol] | [symbol] | [symbol] | [symbol] |
| 37 | 37 | [symbol] | [symbol] | [symbol] | [symbol] | [symbol] | [symbol] | [symbol] | [symbol] | [symbol] |
| 38 | 38 | [symbol] | [symbol] | [symbol] | [symbol] | [symbol] | [symbol] | [symbol] | [symbol] | [symbol] |
| 39 | 39 | [symbol] | [symbol] | [symbol] | [symbol] | [symbol] | [symbol] | [symbol] | [symbol] | [symbol] |
| 40 | 40 | [symbol] | [symbol] | [symbol] | [symbol] | [symbol] | [symbol] | [symbol] | [symbol] | [symbol] |
| 41 | 41 | [symbol] | [symbol] | [symbol] | [symbol] | [symbol] | [symbol] | [symbol] | [symbol] | [symbol] |
| 42 | 42 | [symbol] | [symbol] | [symbol] | [symbol] | [symbol] | [symbol] | [symbol] | [symbol] | [symbol] |
| 43 | 43 | [symbol] | [symbol] | [symbol] | [symbol] | [symbol] | [symbol] | [symbol] | [symbol] | [symbol] |
| 44 | 44 | [symbol] | [symbol] | [symbol] | [symbol] | [symbol] | [symbol] | [symbol] | [symbol] | [symbol] |

[symbol]

indicates data missing or illegible when filed

### Examples 1 to 40 and Comparative Examples 1 to 4

A color laser printer HP LaserJet Enterprise Color M555dn (Hewlett-Packard Company) equipped with a one-component toner contact development blade cleaning system and HP212X black toner cartridge (W2120X) CRG, which is a consumable cartridge for the printer were modified and used as an image forming apparatus for evaluating the performance of each toner.

The main body was modified such that the process speed was set to 150% and a printing test could be performed only with a black station. Further, the cartridge was modified such that the capacity of the toner container was increased and the toner container was filled with the toner in the toner filling amount described below, and the following evaluations 1 to 4 were performed. In this manner, the evaluation of the durability with a longer lifetime was performed on the main body operated at a higher speed than in the related art. The evaluation results are listed in Table 5.

### Evaluation 1. Offset of Solid Image in Normal-Temperature and Normal-Humidity Environment

The offset of a solid image in a normal-temperature and normal-humidity environment (at a temperature of 25° C. and a relative humidity of 55%) was evaluated as the evaluation of the fixing quality of a fixed image. The printer main body and the toner cartridge filled with 550 g of the toner of each example were allowed to stand for 24 hours in an environment of 25° C. and 55% RH for the purpose of adjusting the temperature and the humidity in the evaluation environment. Thereafter, 50 sheets of solid (amount of toner applied: 0.6 mg/cm²) images were printed out on one side of LETTER size XEROX 4200 paper (manufactured by XEROX Corporation, basis weight of 75 g/m²) in the environment, and the paper after the image formation was stacked such that the black surface without the image was stacked on the surface on which the image had been formed.

Next, the stacked paper was turned over, and lines were drawn on the blank surface on which the image had not been formed using a 2H pencil at an angle of 45°±1° and a weight of 1 kg (9.8 N). Thereafter, the paper underneath the paper on which lines had been drawn with a pencil was used to evaluation the offset according to the following evaluation criteria. The level of C or higher was determined to be satisfactory.

### Evaluation Criteria

A: The offset was not found at all on the blank paper.
B: Black stains in the form of dots were slightly found on the blank paper.
C: Black stains in the form of lines were slightly found on the blank paper.
D: Offset along the lines drawn with a pencil was slightly found on the blank paper.
E: Offset along the lines drawn with a pencil was clearly found on the blank paper.

### Evaluation 2. Low-Temperature Fixability (Rubbing Density-Decreasing Rate of Halftone Image in Low-Temperature and Low-Humidity Environment

The evaluation was performed in a low-temperature and low-humidity environment (a temperature of 15° C. and a relative humidity of 10%), which is a severe environment for the evaluation of low-temperature fixability. The printer main body and the toner cartridge filled with 550 g of the toner of each example were allowed to stand for 24 hours in an environment of 15° C. and 10% RH for the purpose of adjusting the temperature and the humidity in the evaluation environment. COTTON BOND LIGHT COCKLE (basis weight of 90 g/m²), which is rough paper that is likely to be disadvantageous in terms of the low-temperature fixability due to the unevenness of paper, was used as evaluation paper.

As the evaluation procedures, the density of a halftone image was adjusted such that the image density (measured using a potable spectrophotometer e Xact Advanced (manufactured by X-Rite, Inc.)) was set to be in a range of 0.75 to 0.80 at a set temperature of 170° C. from a state in which the entire fixing device was at room temperature, and 10 sheets of images were output.

Thereafter, an image was output at a set temperature of 150° C., and the fixed image was rubbed ten times with lens-cleansing paper to which a load of 5.4 kPa was applied. The density-decreasing rate at 150° C. was calculated from the image densities before and after the rubbing using the following equation.

$$Density - decreasing rate ( \% ) = ( image density before rubbing - image density after rubbing ) / image density before rubbing \times 100$$

Similarly, the fixing temperature was increased by 5° C. at a time, and the density-decreasing rate was calculated up to a temperature of 200° C.

A relational formula between the fixing temperature and the density-decreasing rate was obtained by performing quadratic polynomial approximation based on the evaluation results of the fixing temperature and the density-decreasing rate obtained from the series of operations. The temperature at which the temperature-decreasing rate reached 15% was calculated using the relational formula, and set as the fixing temperature indicating the threshold for a satisfactory low-temperature fixability.

The low-temperature fixability is satisfactory as the fixing temperature decreases, and the level of C or higher is acceptable in the present disclosure.

Evaluation criteria
A: The fixing temperature was lower than 180° C.
B: The fixing temperature was 180° C. or higher and lower than 190° C.
C: The fixing temperature was 190° C. or higher and lower than 200° C.
D: The fixing temperature was 200° C. or higher.

### Evaluation 3. Evaluation of Transfer Efficiency of Solid Image in Low-Temperature and Low-Humidity Environment

The transfer efficiency in a low-temperature and low-humidity environment (a temperature of 15° C. and a relative humidity of 10%) was evaluated at the evaluation of the transferability. The printer main body and the toner cartridge filled with 550 g of the toner of each example were allowed to stand for 24 hours in an environment of 15° C. and 10% RH for the purpose of adjusting the temperature and the humidity in the evaluation environment. Thereafter, 50 sheets of solid images were output in the same environment, solid images were output again, and the development process was forcibly stopped when the toner was transferred to the intermediate transfer belt. Thereafter, the toner transferred onto the intermediate transfer belt and the toner remaining on the photosensitive drum after the transfer were peeled off with transparent polyester pressure-sensitive adhesive tape. The density difference was calculated by subtracting the toner density of the paper onto which only pressure-sensitive adhesive tape was attached from the toner density of the paper onto which the pressure-sensitive adhesive tape that had been peeled off was attached.

The transfer efficiency is the proportion of the toner density difference on the intermediate transfer belt in a case where the sum of the respective toner concentration differences is set to 100. The transfer efficiency is excellent as the proportion thereof increases. The transfer efficiency after the output was evaluated according to the following evaluation criteria. Further, the toner density was measured with “504 spectrodensitometer” (manufactured by X-Rite, Inc.).

The evaluation criteria are as follows.

### Evaluation Criteria

A: The transfer efficiency was 99% or greater.
B: The transfer efficiency was 97% or greater and less than 99%.
C: The transfer efficiency was 95% or greater and less than 97%.
D: The transfer efficiency was less than 95%.
   Evaluation 4: Evaluation of Transferability after Endurance Use in Low-Temperature and Low-Humidity Environment (Voids in Thin Vertical Line Image)

The transfer efficiency in a low-temperature and low-humidity environment (a temperature of 15° C. and a relative humidity of 10%) was evaluated at the evaluation of the transferability. The printer main body and the toner cartridge filled with 550 g of the toner of each example were allowed to stand for 24 hours in an environment of 15° C. and 10% RH for the purpose of adjusting the temperature and the humidity in the evaluation environment. Thereafter, 20,000 sheets of images were output with a printing ratio of 1.0% in the same environment, and the evaluation images were output in the same manner as described above such that two vertical lines each formed of 2, 4, 6, 8, and 10 dots were drawn with a non-latent image area width of about 10 mm between lines. The printed evaluation images were visually observed with a 20× loupe, and the evaluation was performed according to the following criteria.

### Evaluation Criteria

A: Almost no voids were confirmed in two-dot lines even by magnifying observation.
B: Voids were slightly confirmed in two-dot lines by magnifying observation, and almost no voids were confirmed in four-dot lines by magnifying observation.
C: Voids were slightly confirmed in four-dot lines by magnifying observation, and voids were not visually confirmed in two-dot lines.
D: Voids were visually confirmed in two-dot lines, and voids were not visually confirmed in four-dot lines.
E: Voids were visually confirmed in four-dot lines.

TABLE 5

| Example | Toner particles | [symbol] | [symbol] | [symbol] | [symbol] |
|---|---|---|---|---|---|
| Example 1 | Toner particles 1 | [symbol] | [symbol] | [symbol] | [symbol] |
| Example 2 | Toner particles 2 | [symbol] | [symbol] | [symbol] | [symbol] |
| Example 3 | Toner particles 3 | [symbol] | [symbol] | [symbol] | [symbol] |
| Example 4 | Toner particles 4 | [symbol] | [symbol] | [symbol] | [symbol] |
| Example 5 | Toner particles 5 | [symbol] | [symbol] | [symbol] | [symbol] |
| Example 6 | Toner particles 6 | [symbol] | [symbol] | [symbol] | [symbol] |
| Example 7 | Toner particles 7 | [symbol] | [symbol] | [symbol] | [symbol] |
| Example 8 | Toner particles 8 | [symbol] | [symbol] | [symbol] | [symbol] |
| Example 9 | Toner particles 9 | [symbol] | [symbol] | [symbol] | [symbol] |
| Example 10 | Toner particles 10 | [symbol] | [symbol] | [symbol] | [symbol] |
| Example 11 | Toner particles 11 | [symbol] | [symbol] | [symbol] | [symbol] |
| Example 12 | Toner particles 12 | [symbol] | [symbol] | [symbol] | [symbol] |
| Example 13 | Toner particles 13 | [symbol] | [symbol] | [symbol] | [symbol] |
| Example 14 | Toner particles 14 | [symbol] | [symbol] | [symbol] | [symbol] |
| Example 15 | Toner particles 15 | [symbol] | [symbol] | [symbol] | [symbol] |
| Example 16 | Toner particles 16 | [symbol] | [symbol] | [symbol] | [symbol] |
| Example 17 | Toner particles 17 | [symbol] | [symbol] | [symbol] | [symbol] |
| Example 18 | Toner particles 18 | [symbol] | [symbol] | [symbol] | [symbol] |
| Example 19 | Toner particles 19 | [symbol] | [symbol] | [symbol] | [symbol] |
| Example 20 | Toner particles 20 | [symbol] | [symbol] | [symbol] | [symbol] |
| Example 21 | Toner particles 21 | [symbol] | [symbol] | [symbol] | [symbol] |
| Example 22 | Toner particles 22 | [symbol] | [symbol] | [symbol] | [symbol] |
| Example 23 | Toner particles 23 | [symbol] | [symbol] | [symbol] | [symbol] |
| Example 24 | Toner particles 24 | [symbol] | [symbol] | [symbol] | [symbol] |
| Example 25 | Toner particles 25 | [symbol] | [symbol] | [symbol] | [symbol] |
| Example 26 | Toner particles 26 | [symbol] | [symbol] | [symbol] | [symbol] |
| Example 27 | Toner particles 27 | [symbol] | [symbol] | [symbol] | [symbol] |
| Example 28 | Toner particles 28 | [symbol] | [symbol] | [symbol] | [symbol] |
| Example 29 | Toner particles 29 | [symbol] | [symbol] | [symbol] | [symbol] |
| Example 30 | Toner particles 30 | [symbol] | [symbol] | [symbol] | [symbol] |
| Example 31 | Toner particles 31 | [symbol] | [symbol] | [symbol] | [symbol] |
| Example 32 | Toner particles 32 | [symbol] | [symbol] | [symbol] | [symbol] |
| Example 33 | Toner particles 33 | [symbol] | [symbol] | [symbol] | [symbol] |
| Example 34 | Toner particles 34 | [symbol] | [symbol] | [symbol] | [symbol] |
| Example 35 | Toner particles 35 | [symbol] | [symbol] | [symbol] | [symbol] |
| Example 36 | Toner particles 36 | [symbol] | [symbol] | [symbol] | [symbol] |
| Example 37 | Toner particles 37 | [symbol] | [symbol] | [symbol] | [symbol] |
| Example 38 | Toner particles 38 | [symbol] | [symbol] | [symbol] | [symbol] |
| Example 39 | Toner particles 39 | [symbol] | [symbol] | [symbol] | [symbol] |
| Example 40 | Toner particles 40 | [symbol] | [symbol] | [symbol] | [symbol] |
| Comparative Example 1 | Toner particles 41 | [symbol] | [symbol] | [symbol] | [symbol] |
| Comparative Example 2 | Toner particles 42 | [symbol] | [symbol] | [symbol] | [symbol] |
| Comparative Example 3 | Toner particles 43 | [symbol] | [symbol] | [symbol] | [symbol] |
| Comparative Example 4 | Toner particles 44 | [symbol] | [symbol] | [symbol] | [symbol] |

[symbol]

indicates data missing or illegible when filed

According to the present disclosure, it is possible to achieve both the fixability and the transferability of the toner. Therefore, it is possible to provide a toner that suppresses offset of a solid image, has excellent low-temperature fixability, and is capable of suppressing voids caused by degradation of the transfer efficiency and transfer defects of a solid image in a low-temperature and low-humidity environment.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2024-061897, filed Apr. 8, 2024 and Japanese Patent Application No. 2025-039231, filed Mar. 12, 2025, which are hereby incorporated by reference herein in their entirety.

What is claimed is:

1. A toner comprising:
a toner particle that contains a binder resin; and
an external additive,
wherein 1) the binder resin contains 50% by mass or greater of polyester A, and the polyester A contains 90% by mole or greater of an isophthalic acid unit Uᵢₛₒ with respect to an amount of all units derived from an acid component, and
2) the external additive contains a titanate fine particle.

2. The toner according to claim 1,
wherein the polyester A has a unit U_{EO} of an ethylene oxide adduct of bisphenol A and a unit U_{PO} of a propylene oxide adduct of bisphenol A, and
a total content proportion of the unit U_{EO} and the unit U_{PO} is 90% by mole or greater with respect to the amount of all the units derived from the alcohol component.

3. The toner according to claim 2,
wherein the content proportion of the unit Uro is 15% by mole or greater and 40% by mole or less with respect to the total content proportion of the unit U_{EO} and the unit U_{PO}.

4. The toner according to claim 1,
wherein a number average molecular weight (Mn) and a weight-average molecular weight (Mw) of tetrahydrofuran (THF) soluble matter of the polyester A, which are measured by gel permeation chromatography (GPC), satisfy:
$$3 , 000 \leq Mn \leq 10 , 000 , \\ Mw / Mn \geq 2.5 .$$

5. The toner according to claim 1,
wherein the toner particle contains 0.015% by mass or greater and 0.150% by mass or less of an aluminum element.

6. The toner according to claim 1,
wherein the binder resin contains crystalline polyester.

7. The toner according to claim 1,
wherein the toner has an average circularity of 0.950 or greater and 0.980 or less.

8. The toner according to claim 1,
wherein the titanate fine particle is at least one fine particle selected from the group consisting of a strontium titanate fine particle, a calcium titanate fine particle, and a barium titanate fine particle.

9. The toner according to claim 1,
wherein the titanate fine particle has a relative dielectric constant of 100 or greater and 2,000 or less.

10. The toner according to claim 1,
wherein a content of the titanate fine particle in the toner is 0.01% by mass or greater and 5.00% by mass or less.

11. The toner according to claim 1,
wherein in a case where a content of the titanate fine particle with respect to 100 parts by mass of the toner particle is defined as A (parts by mass), a content proportion of the isophthalic acid unit Uᵢₛₒ with respect to the amount of all the units derived from the acid component constituting the polyester A is defined as B (% by mole), and a content proportion of the polyester A in the binder resin is defined as C (% by mass), A, B, and C satisfy:
$$1.0 \times 1 {0}^{- 5} \leq A / ( B \times C ) \leq 1.1 \times 1 {0}^{- 4} . \qquad ( 1 )$$

12. The toner according to claim 1,
wherein the titanate fine particle has a surface treated with a silane coupling agent or a fatty acid.
